(19) United States
(12) Patent Application Publication
(10) Pub. No.: US 2026/0331893 A1
(43) Pub. Date: Oct. 22, 2026

(54) EXTENSION ARM OF STEEL CROSSARM FOR INDIRECT LIVE LINE, METHOD FOR ESTABLISHING INDIRECT LIVE LINE WORK SAFETY DISTANCE USING SAME, AND INDIRECT LIVE LINE UNINTERRUPTIBLE POWER DISTRIBUTION METHOD BASED ON METHOD FOR ESTABLISHING INDIRECT LIVE LINE WORK SAFETY DISTANCE

(71) Applicants: DAEWON ELECTRIC CO.,LTD., Cheongju-si (KR); DAEWON INDUSTRY COMPANY, Jeungpyeong-gun (KR)

(72) Inventor: Sae Won KWON, Jeungpyeong-gun (KR)

(21) Appl. No.: 19/467,823

(22) Filed: Feb. 3, 2026

Related U.S. Application Data
(63) Continuation of application No. PCT/KR2024/014942, filed on Oct. 2, 2024.

(30) Foreign Application Priority Data
Oct. 16, 2023 (KR) 10-2023-0137787

(51) Int. Cl. H02G 7/20; H02G 1/04

(52) U.S. Cl. CPC H02G 7/20; H02G 1/04

(57) ABSTRACT

Provided is an extension arm for a steel crossarm supports indirect live-line work on electric power distribution lines. The arm attaches to and extends a steel crossarm, and it shifts a distribution-line conductor away from the work zone to maintain a working clearance on lines having one or more circuits, including upper and lower circuits. The extension arm is used during energized-line construction and maintenance tasks such as utility-pole replacement, steel-crossarm replacement, suspension/LP insulator replacement, angle adjustment, lightning-arrester installation and removal, sub-pole installation, protective-device installation and removal, jumper-wire replacement, wire replacement, line inspection, and switch installation and removal. Methods of use secure the clearance distance with the extension arm and perform indirect live-line, uninterruptible distribution work based on the secured clearance.

### TECHNICAL FIELD

The present invention relates to a method for securing a safety distance for indirect live-line work for a live distribution line, and a method for performing uninterruptible power distribution construction by indirect live-line work based on the method for securing a safety distance. More specifically, the present invention relates to: an extension arm of a steel crossarm for indirect live-line work capable of securing a sufficient safety distance for indirect live-line work for distribution lines including one or more circuits and, while maintaining the safety distance for indirect live-line work, enabling various operations, such as utility pole replacement, steel crossarm replacement, suspension insulator replacement, LP insulator replacement, angle adjustment, installation and removal of an LA, sub-pole installation, protective device installation and removal, jumper wire replacement, wire replacement, line inspection by type, and switch installation and removal to be performed simply and safely by indirect live-line work for the distribution lines including one or more circuits and an upper distribution line disposed above the same; a method for securing a safety distance for indirect live-line work using the same; and an indirect live-line uninterruptible power distribution method based on the method for securing a safety distance for indirect live-line work.

### BACKGROUND ART

Recently, power facilities have been continuously expanded to accommodate the surge in electricity demand. As power users'demands for electric power quality have increased, even momentary power outages have become a source of public complaints, leading to a rise in collective action and lawsuits by power users seeking compensation. Therefore, to ensure a high-quality power supply during distribution work, uninterruptible power methods are being implemented, which allow construction work to proceed without interrupting power.

Meanwhile, conventional uninterruptible power distribution methods include a mobile transformer wagon method, a bypass jumper cable method, and a construction switch method. However, the bypass jumper cable method involves installing bypass cables and other equipment directly on the live-line, after preparing a cable wagon, cables required for the work section, a construction switch, a mobile transformer wagon, a live-line bucket truck, and a set of live-line work tools, thereby bypassing the power supply. Subsequently, distribution lines are replaced, a steel crossarm is replaced, and relocation work is performed. Finally, the bypass cables and other equipment are removed directly on the live-line, thereby completing the distribution work.

In addition, for distribution lines having a power capacity exceeding 5,000 kW, when work is performed using the existing bypass jumper cable method, the allowable capacity of a cable used in the existing cable method is 5,000 kW or less. Therefore, significant time and labor costs are wasted in switching power loads to other distribution lines in order to reduce the capacity of the distribution line to 5,000 kW or less, and serious problems occur in the effective operation of the distribution line system.

Accordingly, to address the above-described problems, indirect live-line work using insulated tools, such as a live-line work stick, has recently been utilized.

However, such general indirect live-line work may be very useful for work on a distribution line including a single circuit. In the case of distribution lines including one or more upper and lower circuits, it is difficult to secure a sufficient safety clearance distance for indirect live-line work, particularly during work on an upper distribution line. Therefore, there is a need to provide an appropriate work method for distribution lines including one or more upper and lower circuits.

Therefore, work is carried out in a power-outage state, or construction costs increase by three to ten times. In addition, although uninterruptible work is carried out using the bypass cable method, switch accidents frequently occur during construction.

### PATENT DOCUMENT

(Patent Document 1) Korean Patent Laid-Open Publication No. 10-2010-0036065

(Patent Document 2) Korean Patent Registration Publication No. 10-2161405

(Patent Document 3) Korean Patent Registration Publication No. 10-2232560

### SUMMARY OF INVENTION

The present invention was conceived to address the above-described problems, and it is an object to provide an extension arm of a steel crossarm for indirect live-line work for securing a safety distance for indirect live-line work by extending a steel crossarm of a distribution line during indirect live-line work, a method for securing a safety distance for indirect live-line work using the same, and an indirect live-line uninterruptible power distribution method based on the method for securing a safety distance for indirect live-line work.

In addition, another object of the present invention is to provide: an extension arm of a steel crossarm for indirect live-line work that secures a safety distance for indirect live-line work by extending the steel crossarm and moving the wire for distribution lines including one or more upper and lower circuits, and, while enabling a worker to safely access the distribution lines and maintain a safe working distance during indirect live-line work, enables indirect live-line work such as utility pole replacement, steel crossarm replacement, suspension insulator replacement, LP insulator replacement, angle adjustment, installation and removal of an LA, sub-pole installation, protective device installation and removal, jumper wire replacement, wire replacement, line inspection by type, and switch installation and removal for distribution lines including one or more circuits and an upper distribution line disposed above the same; a method for securing a safety distance for indirect live-line work using the same; and an indirect live-line uninterruptible power distribution method based on the method for securing a safety distance for indirect live-line work.

### Means for Solving Problems

To achieve the above objects, the present invention provides an extension arm of a steel crossarm for indirect live-line work, including: a tubular coupling part having one end open forward and coupled to an end of a steel crossarm of a utility pole; an extension part extending from a rear end of the coupling part and having a plurality of mounting holes; and a mounting means formed on the coupling part and configured to apply a fixing force to fasten the coupling part to the steel crossarm, wherein the mounting means includes: a support plate formed in a front-rear longitudinal direction, including spacers formed in all directions at a central portion thereof, a guide pin formed at a center of a rear end thereof, a spring support pin formed at the central portion, and a lever guide hole formed as a horizontal slot on a rear side of the spring support pin; an operating plate accommodated between the spacers to slide forward and backward, and including a catch extension formed at a tip end thereof, a spring guide groove formed as a horizontal slot at a front-middle portion thereof and penetrated by the spring support pin, a spring elastically installed on the spring support pin to apply a forward movement force, and a guide pin guide groove formed at a rear end thereof and configured to accommodate and guide the guide pin; a fastener including a pair of fasteners disposed on both sides in a width direction, each fastener having a rear end axially coupled to a front side of the support pin, each fastener having a pivot and an opening spring elastically installed to apply an elastic force to spread forward, and each fastener including a pin fixing groove defined by mutually facing front portions, and a catch groove defined by mutually facing rear portions and having a rearwardly expanding step to which the catch extension of the operating plate is engaged; and an operating lever penetrating the lever guide hole of the support plate and coupled to the operating plate, and configured to apply a backward movement force to the operating plate by indirect live-line work from outside using a live-line work stick.

In addition, a method for securing a safety distance for indirect live-line work using an extension arm of a steel crossarm performs indirect live-line work on extra-high-voltage distribution lines including one or more upper and lower circuits using the extension arm of a steel crossarm for indirect live-line work, and the method includes: a work preparation process of carrying live-line work equipment, such as an extension arm of a steel crossarm for indirect live-line work for extending a steel crossarm, including a live-line work stick, and moving to the distribution line using a live-line bucket; a steel crossarm extension process of extending the steel crossarm by coupling the extension arm of a steel crossarm for indirect live-line work to one or both sides of a steel crossarm of the distribution line by indirect live-line work using the live-line work stick and the live-line work equipment; a safety distance securing process of securing a safety distance for indirect live-line work by moving a wire of the distribution line to the extension arm of a steel crossarm for indirect live-line work; a wire return process of moving the wire of the distribution line, which has been moved to the extension arm of a steel crossarm for indirect live-line work, back to the steel crossarm; and a finishing process of removing the live-line work equipment, such as the extension arm of a steel crossarm for indirect live-line work, using the live-line work stick and the live-line work equipment.

In addition, an indirect live-line uninterruptible power distribution method based on the method for securing a safety distance for indirect live-line work using an extension arm of a steel crossarm performs indirect live-line work on extra-high-voltage distribution lines including one or more upper and lower circuits using the extension arm of a steel crossarm for indirect live-line work, and the method includes: a work preparation process of carrying live-line work equipment, such as an extension arm of a steel crossarm for indirect live-line work for extending a steel crossarm, including a live-line work stick, and moving to the distribution line using a live-line bucket; a steel crossarm extension process of extending the steel crossarm by coupling the extension arm of a steel crossarm for indirect live-line work to one or both sides of a steel crossarm of the distribution line by indirect live-line work using the live-line work stick and the live-line work equipment; a safety distance securing process of securing a safety distance for indirect live-line work by moving a wire of the distribution line to the extension arm of a steel crossarm for indirect live-line work; a main work process of, after a safety distance for indirect live-line work is secured, performing indirect live-line work on the distribution line using the live-line bucket, by a worker; a wire return process of, after the indirect live-line work on the distribution line is completed, moving the wire of the distribution line, which has been moved to the extension arm of a steel crossarm for indirect live-line work, back to the steel crossarm; and a finishing process of removing the live-line work equipment, such as the extension arm of a steel crossarm for indirect live-line work, using the live-line work stick and the live-line work equipment.

### Advantageous Effects

According to the present invention having the above-described configuration, the following effects may be achieved. The extension arm of a steel crossarm for indirect live-line work, the method for securing a safety distance for indirect live-line work using the same, and the indirect live-line uninterruptible power distribution method based on the method for securing a safety distance for indirect live-line work according to the present invention may secure a safety distance for indirect live-line work through extension of the steel crossarm, thereby enabling safe indirect live-line work on a distribution line.

Further, after a safety distance for indirect live-line work is secured by extension of the steel crossarm and movement of wires for distribution lines including one or more upper and lower circuits, a worker may access distribution lines including one or more circuits and an upper distribution line disposed above the same and may safely perform indirect live-line work such as utility pole replacement, steel crossarm replacement, suspension insulator replacement, LP insulator replacement, angle adjustment, installation and removal of an LA, sub-pole installation, protective device installation and removal, jumper wire replacement, wire replacement, line inspection by type, and switch installation and removal.

### BRIEF DESCRIPTION OF DRAWINGS

FIG. 1 is a perspective view of a first embodiment of an extension arm of a steel crossarm for indirect live-line work according to the present invention.

FIG. 2 is a cross-sectional view of the first embodiment of the extension arm of a steel crossarm for indirect live-line work according to the present invention.

FIG. 3 is a perspective view of a second embodiment of the extension arm of a steel crossarm for indirect live-line work according to the present invention.

FIG. 4 is a cross-sectional view of the second embodiment of the extension arm of a steel crossarm for indirect live-line work according to the present invention.

FIG. 5 is a perspective view of a third embodiment of the extension arm of a steel crossarm for indirect live-line work according to the present invention.

FIG. 6 is a cross-sectional view of the third embodiment of the extension arm of a steel crossarm for indirect live-line work according to the present invention.

FIG. 7 is an assembled perspective view of a main portion of mounting means of the extension arm of a steel crossarm for indirect live-line work according to the present invention.

FIG. 8 is an exploded perspective view of the main portion of mounting means of the extension arm of a steel crossarm for indirect live-line work according to the present invention.

FIG. 9 is a cross-sectional view of a main portion of the extension arm of a steel crossarm for indirect live-line work according to the present invention.

FIG. 10 is a view illustrating an operating state of mounting means of the extension arm of a steel crossarm for indirect live-line work according to the present invention.

FIG. 11 is a view illustrating a use state according to a first embodiment of the extension arm of a steel crossarm for indirect live-line work of the present invention.

FIG. 12 is a view illustrating a use state according to a second embodiment of the extension arm of a steel crossarm for indirect live-line work of the present invention.

FIG. 13 is a view illustrating a use state according to a third embodiment of the extension arm of a steel crossarm for indirect live-line work of the present invention.

FIG. 14 is a flowchart illustrating an overall process of a method for securing a safety distance for indirect live-line work using an extension arm of a steel crossarm of the present invention.

FIGS. 15 to 20 are schematic views illustrating an overall process of the method for securing a safety distance for indirect live-line work using an extension arm of a steel crossarm of the present invention or the indirect live-line uninterruptible power distribution method based on the method for securing a safety distance for indirect live-line work using an extension arm of a steel crossarm of the present invention.

FIG. 21 is a flowchart illustrating an overall process of an indirect live-line uninterruptible power distribution method based on the method for securing a safety distance for indirect live-line work using an extension arm of a steel crossarm of the present invention.

FIGS. 22 to 24 are views illustrating an embodiment of utility pole replacement operation on an upper distribution line in a main work process of the indirect live-line uninterruptible power distribution method based on the method for securing a safety distance for indirect live-line work using an extension arm of a steel crossarm of the present invention.

FIGS. 25 to 27 are views illustrating an embodiment of steel crossarm replacement operation for a pin-type pole on an upper distribution line in the main work process of the indirect live-line uninterruptible power distribution method based on the method for securing a safety distance for indirect live-line work using an extension arm of a steel crossarm of the present invention.

FIGS. 28 to 31 are views illustrating an embodiment of suspension insulator replacement operation on an upper distribution line in the main work process of the indirect live-line uninterruptible power distribution method based on the method for securing a safety distance for indirect live-line work using an extension arm of a steel crossarm of the present invention.

FIGS. 32 to 34 are views illustrating an embodiment of LP insulator replacement operation on an upper distribution line in the main work process of the indirect live-line uninterruptible power distribution method based on the method for securing a safety distance for indirect live-line work using an extension arm of a steel crossarm of the present invention.

FIGS. 35 to 38 are views illustrating an embodiment of angle adjustment operation on an upper distribution line in the main work process of the indirect live-line uninterruptible power distribution method based on the method for securing a safety distance for indirect live-line work using an extension arm of a steel crossarm of the present invention.

FIGS. 39 and 40 are views illustrating an embodiment of LA installation operation on an upper distribution line in the main work process of the indirect live-line uninterruptible power distribution method based on the method for securing a safety distance for indirect live-line work using an extension arm of a steel crossarm of the present invention.

FIGS. 41 and 42 are views illustrating an embodiment of LA removal operation on an upper distribution line in the main work process of the indirect live-line uninterruptible power distribution method based on the method for securing a safety distance for indirect live-line work using an extension arm of a steel crossarm of the present invention.

FIGS. 43 to 45 are views illustrating an embodiment of sub-pole installation operation on distribution lines including one or more circuits in the main work process of the indirect live-line uninterruptible power distribution method based on the method for securing a safety distance for indirect live-line work using an extension arm of a steel crossarm of the present invention.

FIGS. 46 to 49 are views illustrating an embodiment of utility pole replacement operation on distribution lines including one or more circuits in the main work process of the indirect live-line uninterruptible power distribution method based on the method for securing a safety distance for indirect live-line work using an extension arm of a steel crossarm of the present invention.

FIGS. 50 to 52 are views illustrating an embodiment of protective device installation operation on an upper distribution line in the main work process of the indirect live-line uninterruptible power distribution method based on the method for securing a safety distance for indirect live-line work using an extension arm of a steel crossarm of the present invention.

FIGS. 53 and 54 are views illustrating an embodiment of protective device removal operation on an upper distribution line in the main work process of the indirect live-line uninterruptible power distribution method based on the method for securing a safety distance for indirect live-line work using an extension arm of a steel crossarm of the present invention.

FIGS. 55 to 57 are views illustrating an embodiment of jumper wire replacement operation on an upper distribution line in the main work process of the indirect live-line uninterruptible power distribution method based on the method for securing a safety distance for indirect live-line work using an extension arm of a steel crossarm of the present invention.

FIGS. 58 and 59 are views illustrating an embodiment of wire replacement operation on an upper distribution line in the main work process of the indirect live-line uninterruptible power distribution method based on the method for securing a safety distance for indirect live-line work using an extension arm of a steel crossarm of the present invention.

FIG. 60 is a view illustrating an embodiment of line inspection by type operation in the main work process of the indirect live-line uninterruptible power distribution method based on the method for securing a safety distance for indirect live-line work using an extension arm of a steel crossarm of the present invention.

FIGS. 61 to 63 are views illustrating an embodiment of switch installation operation on an upper distribution line in the main work process of the indirect live-line uninterruptible power distribution method based on the method for securing a safety distance for indirect live-line work using an extension arm of a steel crossarm of the present invention.

FIGS. 64 to 66 are views illustrating an embodiment of switch removal operation on an upper distribution line in the main work process of the indirect live-line uninterruptible power distribution method based on the method for securing a safety distance for indirect live-line work using an extension arm of a steel crossarm of the present invention.

FIG. 67 is a schematic view illustrating a pole configuration in the indirect live-line uninterruptible power distribution method based on the method for securing a safety distance for indirect live-line work using an extension arm of a steel crossarm of the present invention.

### DESCRIPTION OF REFERENCE NUMERALS

10: Utility pole, 10′: New utility pole
11: Sub-pole
20: Steel crossarm, 21: Steel crossarm
21′: New steel crossarm, 21a: Steel crossarm for a pin-type pole
21b: Steel crossarm for a built-in pole, 22c: Steel crossarm for a single built-in pole
25: Fixing pin, 26: Bolt shackle
26a: Cotter pin, 27: M-bolt
30: Wire, 31: Wire
31a: Dead-end clamp, 32: Overhead ground wire
40: Insulated auxiliary arm for indirect live-line work, 51: Suspension insulator
51′: New suspension insulator, 52: LP insulator
52′: New LP insulator, 53: Lightning arrester (LA)
53a: Ground wire, 53b: Primary-side lead wire
53c: Pole ground wire
55: Protective device, 55a: Protective device inserter
56: Jumper wire, 56a: Bypass jumper cable
56′: New jumper wire, 58: Switch
58a: Switch cable, 60: Wire tensioner
70: Live-line bucket, 80: Live-line work stick
100: Coupling part, 110: Coupling part for a pin-type pole
111: Steel crossarm insertion space, 112: Steel crossarm guide groove
113: Fixing pin guide groove, 114: Pin hook
115: Working hole, 116: Mounting means housing
117: Fixing pin guiding groove, 118: Lever through slot
120: Coupling part for a built-in pole, 121: Steel crossarm insertion space
122: Pin guide groove, 123: Bolt guide groove
125: Mounting means housing, 126: Bolt guiding groove
127: Lever through slot, 128: Inclined reinforcement part
130: Coupling part for a single built-in pole, 131: Pin guide groove
132: Lever through slot
200: Extension part, 210: Mounting hole
300: Mounting means, 310: Support plate
311: Spacer, 312: Guide pin
313: Spring support pin, 314: Lever guide hole
320: Operating plate, 321: Catch extension
322: Spring guide groove, 323: Spring
324: Guide pin guide groove, 330, 330′: Fastener
331: Shaft, 332: Opening spring
333: Pin fixing groove, 334: Hook groove
340: Operating lever
S110: Work preparation process, S120: Steel crossarm extension process
S130: Work safety distance securing process, S140: Wire return process
S150: Finishing process
S210: Work preparation process, S220: Steel crossarm extension process
S230: Work safety distance securing process, S240: Main work process
S250: Wire return process, S260: Finishing process

### MODE FOR CARRYING OUT INVENTION

Terms and words used in this specification and claims should not be construed as limited to their conventional or dictionary meanings. Based on the principle that an inventor may appropriately define the concepts of terms to best describe the invention, the terms and words should be construed as meanings and concepts consistent with the technical spirit of the present invention.

Therefore, the embodiments described in this specification and the configurations depicted in the drawings represent only preferred embodiments of the present invention and do not represent the entire technical spirit of the present invention. Accordingly, it should be understood that various equivalents and modifications may be substituted for them at the time of filing.

Hereinafter, preferred embodiments of the present invention will be described in detail with reference to the accompanying drawings.

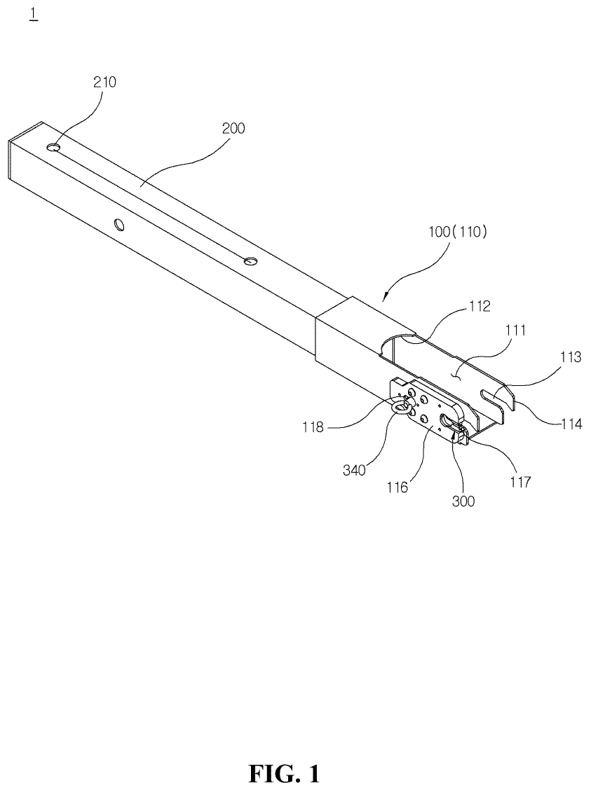

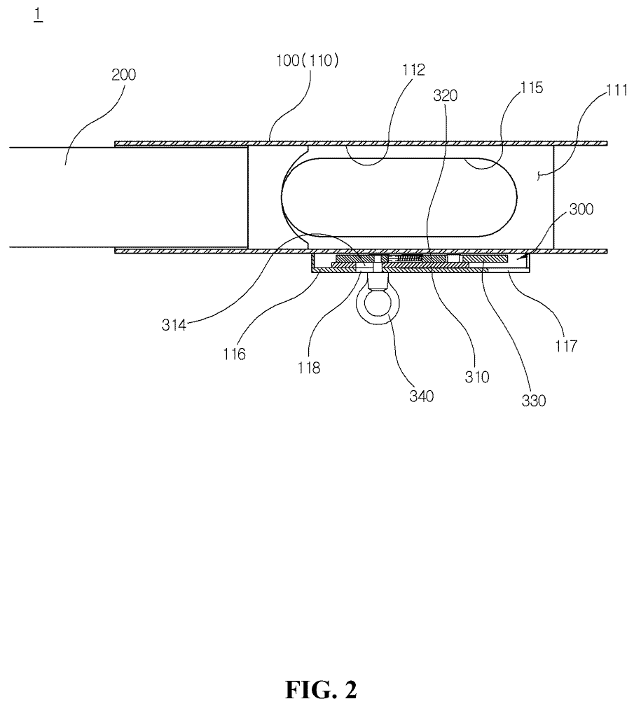

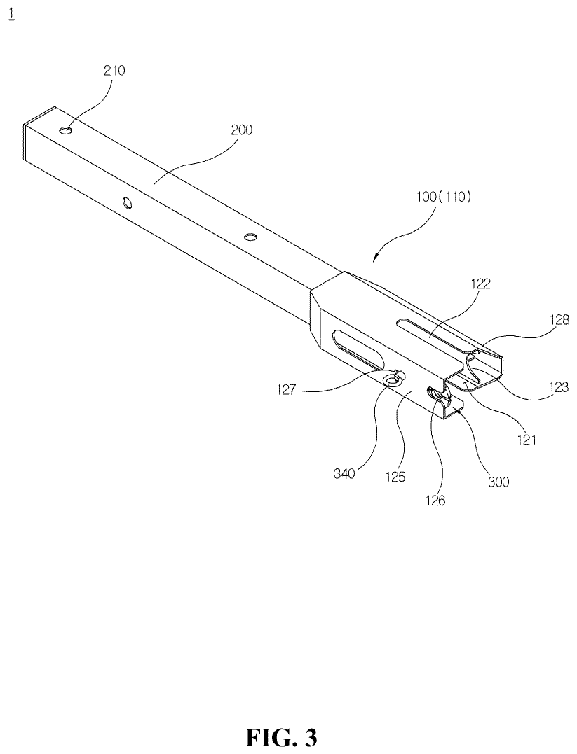

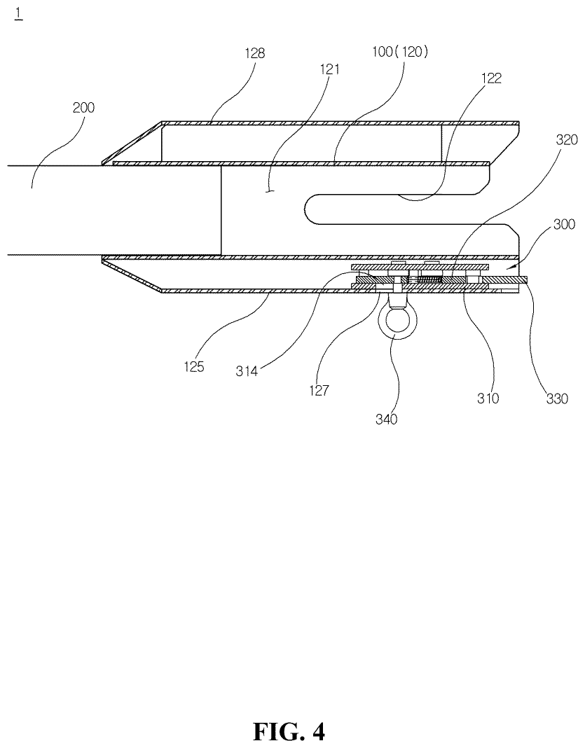

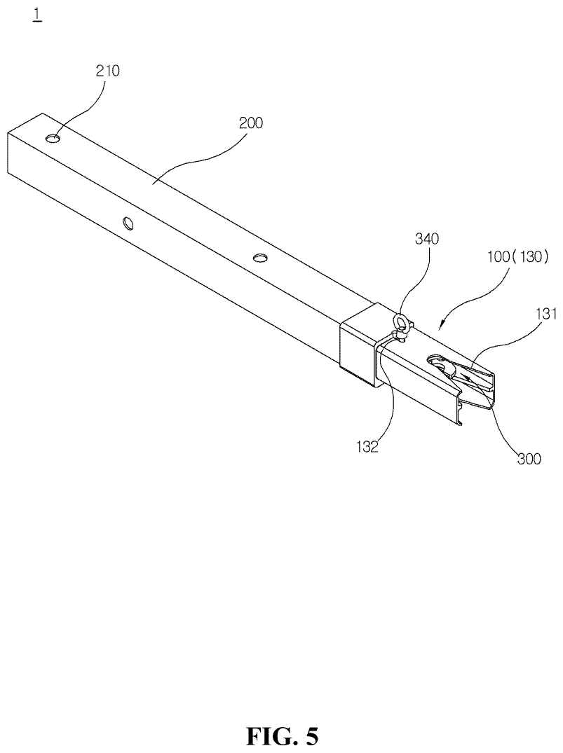

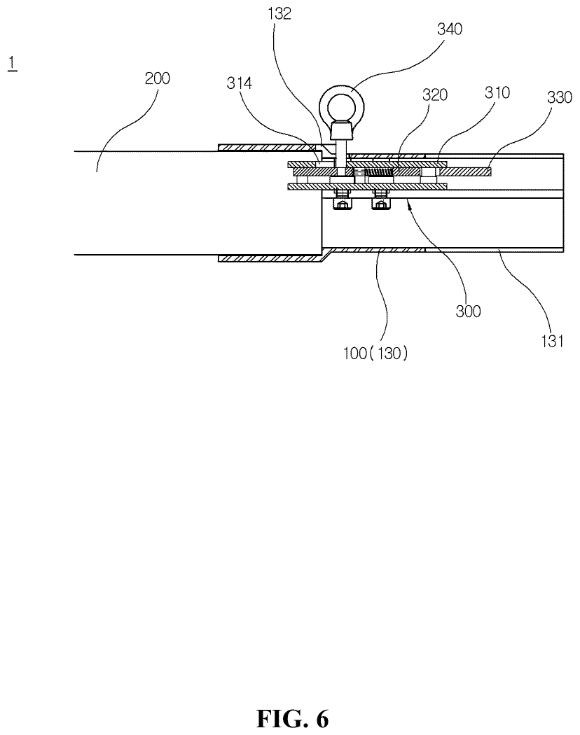

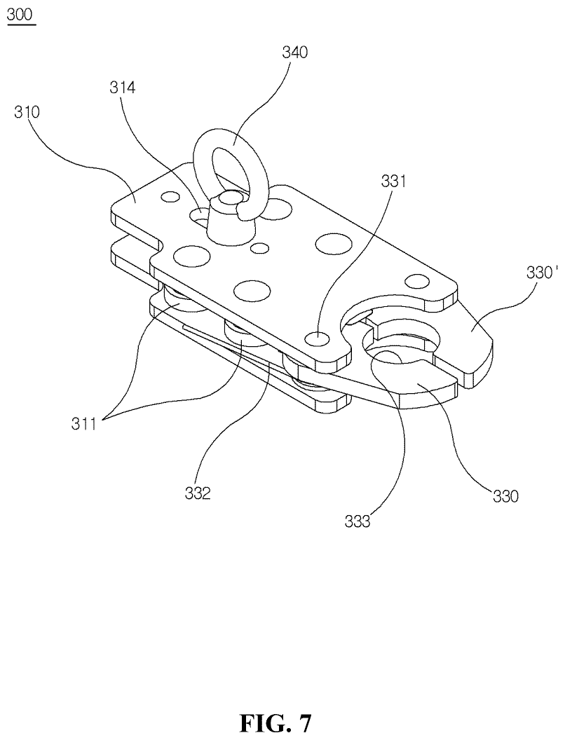

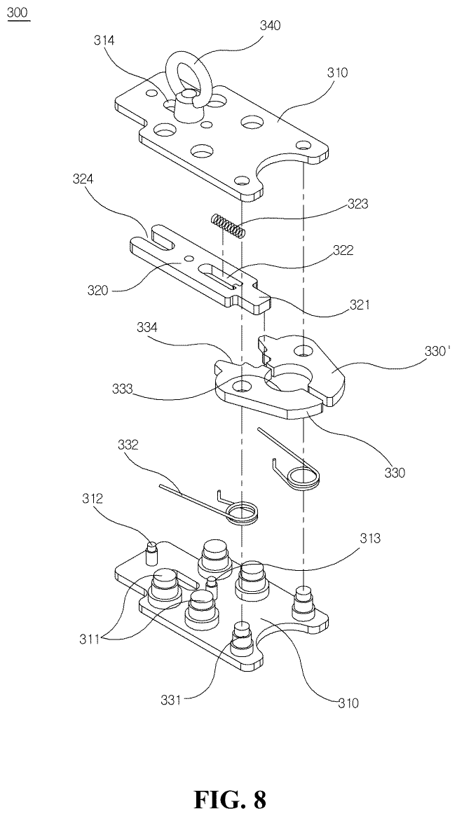

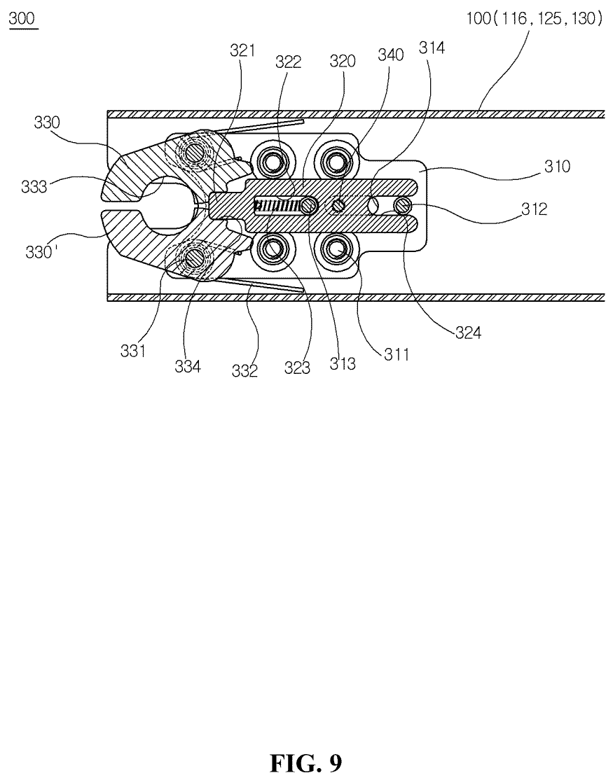

FIG. 1 is a perspective view of a first embodiment of an extension arm of a steel crossarm for indirect live-line work according to the present invention, FIG. 2 is a cross-sectional view of the first embodiment of the extension arm of a steel crossarm for indirect live-line work according to the present invention, FIG. 3 is a perspective view of a second embodiment of the extension arm of a steel crossarm for indirect live-line work according to the present invention, FIG. 4 is a cross-sectional view of the second embodiment of the extension arm of a steel crossarm for indirect live-line work according to the present invention, FIG. 5 is a perspective view of a third embodiment of the extension arm of a steel crossarm for indirect live-line work according to the present invention, FIG. 6 is a cross-sectional view of the third embodiment of the extension arm of a steel crossarm for indirect live-line work according to the present invention, FIG. 7 is an assembled perspective view of a main portion of mounting means of the extension arm of a steel crossarm for indirect live-line work according to the present invention, FIG. 8 is an exploded perspective view of the main portion of mounting means of the extension arm of a steel crossarm for indirect live-line work according to the present invention, and FIG. 9 is a cross-sectional view of a main portion of the extension arm of a steel crossarm for indirect live-line work according to the present invention.

As illustrated in FIGS. 1 to 9, an extension arm 1 of a steel crossarm for indirect live-line work of the present invention includes a coupling part 100, an extension part 200, and a mounting means 300.

First, the coupling part 100, in constituting the extension arm 1 of a steel crossarm for indirect live-line work of the present invention, is configured to be coupled to an end of a steel crossarm of a utility pole.

To this end, the coupling part 100 is formed in a tubular shape open forward to be coupled to the steel crossarm, and is preferably formed in a rectangular tubular shape.

The extension part 200, in constituting the extension arm 1 of a steel crossarm for indirect live-line work of the present invention, extends from a rear end of the coupling part 100 and is preferably configured to be extendable through a coupling structure.

In this case, the extension part 200 is formed in a rectangular tubular shape like a conventional steel crossarm, and a plurality of mounting holes 210 are formed through a central portion thereof in a vertical direction or a horizontal direction to allow mounting of a bolt shackle for installing an LP insulator or a suspension insulator.

The mounting means 300, in constituting the extension arm 1 of a steel crossarm for indirect live-line work of the present invention, is formed on the coupling part 100 and is configured to provide a fastening force when the coupling part 100 is coupled to the steel crossarm, thereby enabling stable mounting and fixing.

To this end, the mounting means 300 first includes a support plate 310, and the support plate 310 is formed in a plate shape extending in a front-rear longitudinal direction. In the present invention, the support plate 310 may be configured as a single member or a pair of members spaced apart symmetrically according to first to third embodiments of the coupling part 100 described below.

In this case, spacers 311 protrude from a surface of the support plate 310 in all directions, a guide pin 312 protrudes from a center of a rear end of the support plate 310, a spring support pin 313 protrudes from a central portion of the support plate 310, and a lever guide hole 314, in the form of a horizontal slot extending in the front-rear direction, is formed through a rear side of the spring support pin 313. When the support plate 310 is configured as the pair of support plates 310, the plates may be connected and spaced apart by the spacers 311, the guide pin 312, and the spring support pin 313.

In addition, the mounting means 300 includes an operating plate 320 configured to be guided by the support plate 310. The operating plate 320 is accommodated between the spacers 311 and configured to slide forward and backward.

In this case, the operating plate 320 includes a catch extension 321 formed at a tip end thereof and configured to restrain expansion of fasteners 330 and 330′, which will be described below.

Further, the operating plate 320 includes a spring guide groove 322 formed through a front-middle portion thereof and having a horizontal slot shape, into which the spring support pin 313 is inserted at a rear side thereof. A spring 323 is elastically installed between the spring support pin 313 and the spring guide groove 322 to apply a forward movement force of the operating plate 320.

Further, the operating plate 320 is formed to be open rearward and includes a guide pin guide groove 324 formed at a rear end thereof, in which the guide pin 312 is accommodated and guided. Accordingly, the operating plate 320 may stably slide along the guide pin guide groove 324.

In addition, the mounting means 300 includes a pair of fasteners 330 and 330′ disposed on both sides in a width direction, which are expanded or folded by sliding restraint of the operating plate 320 to provide a fastening force to the steel crossarm.

In this case, rear ends of the fasteners 330 and 330′ are coupled to a front side of the support plate 310 by a shaft 331 and are configured to pivot in opposite directions in the width direction, and an opening spring 332 is elastically installed in each of the fasteners 330 and 330′ to apply an elastic force for forward expansion.

In addition, each of the fasteners 330 and 330′ includes a pin fixing groove 333 formed in a semicircular arc shape at mutually facing front portions, and a catch groove 334 defined by mutually facing rear portions and configured such that the catch extension 321 of the operating plate 320 is engaged therewith.

In this case, in the present invention, it is preferable that the catch groove 334 has a step. By having a narrow front portion and a wide rear portion, when the catch extension 321 of the operating plate 320 is located at the front portion of the catch groove 334, the opening spring 332 is compressed and front portions of the fasteners 330 and 330′ are folded such that the pin fixing groove 333 is closed. When the catch extension is located at the rear portion of the catch groove 334, front portions of the fasteners 330 and 330′ are expanded by an elastic force of the opening spring 332 such that the pin fixing groove 333 is opened.

In addition, the mounting means 300 includes an operating lever 340 configured to control the sliding movement of the operating plate 320.

In this case, the operating lever 340 penetrates the lever guide hole 314 of the support plate 310 and is coupled to the operating plate 320.

Further, the mounting means 300 includes the operating plate 320 configured to be guided by the support plate 310. The operating plate 320 is accommodated between the spacers 311 and configured to slide forward and backward. The operating lever 340 protruding from the support plate 310 may be operated externally using a conventional live-line work stick.

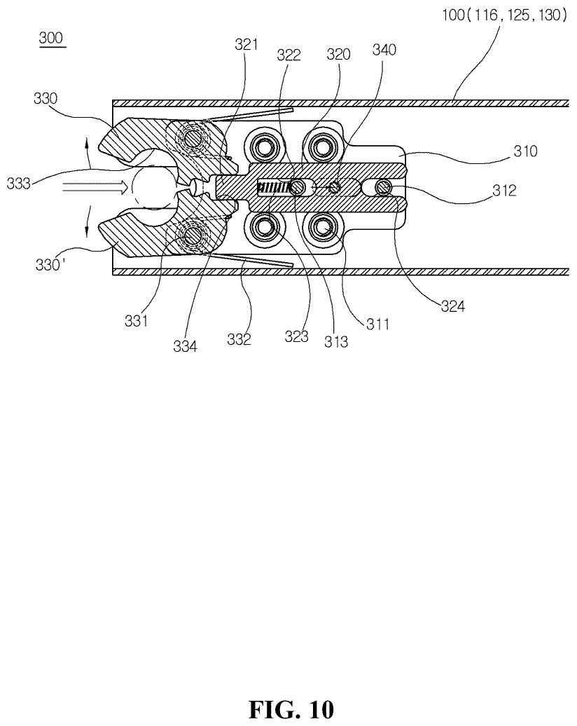

That is, referring to FIG. 10, when the operating lever 340 of the mounting means 300 is retracted rearward, the operating plate 320 moves accordingly. In this case, the catch extension 321 of the operating plate 320 moves to a rear portion of the catch groove 334, and at the same time, the fasteners 330 and 330′ pivot about the shaft 331 by an elastic force of the opening spring 332 such that front portions thereof are expanded, thereby opening the pin fixing groove 333. In this case, when the elastic force acting on the operating lever 340 is released, the operating lever 340 is caught by the step of the catch groove 334 formed as a stepped portion.

Thereafter, when a steel crossarm fixing bolt, an insulator fixing pin, a bolt shackle fixing pin (cotter pin), or the like installed on a conventional steel crossarm is inserted into the open pin fixing groove 333 and the pin fixing groove 333 is pressed, the fasteners 330 and 330′ are expanded to a predetermined angle, and at the same time, the operating plate 320 moves forward by an elastic restoring force of the spring 323 such that the catch extension 321 is inserted into the catch groove 334. In this case, the pin fixing groove 333 is closed to engage the steel crossarm fixing bolt, the insulator fixing pin, the bolt shackle fixing pin (cotter pin), or the like, thereby fastening and fixing the same.

Meanwhile, the extension arm 1 of a steel crossarm for indirect live-line work of the present invention may be configured to be extendably applied in various ways to a steel crossarm for a pin-type pole, a built-in pole, or a single built-in pole of a distribution line through various embodiments of the coupling part 100.

First, the coupling part 100 according to the first embodiment may include a coupling part 110 for a pin-type pole applicable to a steel crossarm for a pin-type pole of a distribution line.

To this end, referring to FIGS. 1 and 2, the coupling part 110 for a pin-type pole first includes a steel crossarm insertion space 111 having a hollow interior and formed to be open forward such that the steel crossarm for a pin-type pole is insertable therein.

Further, the coupling part for a pin-type pole includes a steel crossarm guide groove 112 formed on an upper surface thereof, cut to open forward and allowing insertion of the steel crossarm into the steel crossarm insertion space 111.

Further, the coupling part for a pin-type pole includes a pair of fixing pin guide grooves 113 formed by being cut in central portions of both side surfaces thereof and opened forward to accommodate fixing pins (not illustrated) additionally installed on the steel crossarm for a pin-type pole.

Further, the coupling part for a pin-type pole includes pin hooks 114 having upper portions protruding forward on both side surfaces and inclined downward about the fixing pin guide grooves 113 at a predetermined angle, thereby allowing the coupling part 110 for a pin-type pole to be hung on the fixing pins additionally installed as described above when the coupling part for a pin-type pole is installed.

Further, the coupling part for a pin-type pole includes a working hole 115 formed through a bottom surface thereof to communicate with the steel crossarm insertion space 111 and allow entry of a tool or the like.

Further, the coupling part for a pin-type pole further includes a mounting means housing 116 formed on one side surface thereof to constitute the mounting means 300. In this case, the mounting means housing 116 is open forward and includes a fixing pin guiding groove 117 formed at a tip end of the one side surface corresponding to the fixing pin guide grooves 113, and a lever through slot 118 formed at a central portion thereof corresponding to the lever guide hole 314 of the support plate 310.

Accordingly, the mounting means 300 is configured such that, when mounted, the support plate 310 is fixed to an inner side of the mounting means housing 116 so that the fasteners 330 and 330′ are positioned forward, and one end of the opening spring 332 is elastically installed at a rear side of the fasteners 330 and 330′ and the other end is supported by a side surface of the mounting means housing 116, thereby providing an elastic force for expanding the fasteners 330 and 330′.

In addition, the operating lever 340, when mounted, passes through the lever through slot 118 and the lever guide hole 314 and is fixed to the operating plate 320.

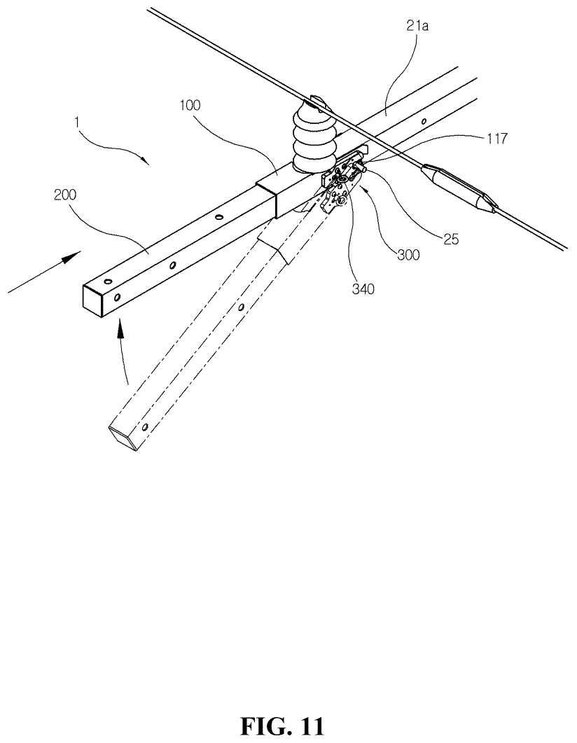

Therefore, when the configuration of the coupling part 100 as described above is applied to the coupling part 110 for a pin-type pole, as illustrated in FIG. 11, a separate fixing pin 25 for installing the extension arm 1 of a steel crossarm for indirect live-line work of the present invention may be installed by horizontally inserting the fixing pin 25 into a steel crossarm 21a for a pin-type pole.

In addition, the fixing pin 25 is coupled to the steel crossarm 21a for a pin-type pole through the coupling part 110 for a pin-type pole, and while an upper portion of the fixing pin 25 is supported by being hooked by the pin hook 114, the steel crossarm 21a for a pin-type pole may be horizontally coupled such that the steel crossarm 21a for a pin-type pole is accommodated in the steel crossarm guide groove 112 formed at an upper portion thereof.

Accordingly, the fixing pin 25 is inserted into the fixing pin guide groove 113 and engaged therewith, and an end of the steel crossarm 21a for a pin-type pole is inserted into the steel crossarm insertion space 111. In this case, interference with an LP insulator 52 is prevented through the steel crossarm guide groove 112 cut in the upper portion, and thus the extension arm 1 of a steel crossarm for indirect live-line work of the present invention may be coupled to the steel crossarm 21a for a pin-type pole through the coupling part 110 for a pin-type pole. When coupled in this manner, the extension part 200 protrudes horizontally, thereby enabling extension of a length of the steel crossarm 21a for a pin-type pole.

Meanwhile, when the coupling part 110 for a pin-type pole is coupled as described above and the mounting means 300 is fastened and fixed, the fixing pin 25 may be hooked, fastened, and fixed to the fasteners 330 and 330′ by operating the operating lever 340 using a live-line work stick as described above through expansion or folding of the fasteners 330 and 330′.

In addition, the coupling part 100 according to the second embodiment may include a coupling part 120 for a built-in pole configured to be applicable to a steel crossarm of a built-in pole of a distribution line.

To this end, referring to FIGS. 3 and 4, the coupling part 120 for a built-in pole first includes a steel crossarm insertion space 121 formed therein as a hollow space and opened forward to allow insertion of the steel crossarm for a built-in pole.

Further, the coupling part for a built-in pole includes a pair of pin guide grooves 122 formed by being cut in centers of upper and lower surfaces thereof and opened forward to guide a cotter pin of a bolt shackle (not illustrated) for installing a suspension insulator on the steel crossarm for a built-in pole.

Further, the coupling part for a built-in pole includes a pair of bolt guide grooves 123 formed by being cut in central portions of front ends of both side surfaces thereof and opened forward to accommodate a bolt (not illustrated) for connecting steel crossarms for built-in poles to each other.

Further, the coupling part for a built-in pole further includes a mounting means housing 125 formed on one side thereof to constitute the mounting means 300. In this case, the mounting means housing 125 includes a bolt guiding groove 126 having one side surface opened forward and formed at a tip end thereof corresponding to the bolt guide groove 123, and a lever through slot 127 formed at a central portion thereof corresponding to the lever guide hole 314 of the support plate 310.

Further, the coupling part for a built-in pole includes an inclined reinforcement part 128 protruding from the other side surface to be inserted and installed through an inner side of a bolt shackle that is commonly formed by bending.

Therefore, the mounting means 300 is configured such that, when mounted, the support plate 310 is fixed to an inner side of the mounting means housing 125 so that the fasteners 330 and 330′ are positioned forward, and one end of the opening spring 332 is elastically installed at a rear side of the fasteners 330 and 330′ and the other end is supported by a side surface of the mounting means housing 125, thereby providing an elastic force for expanding the fasteners 330 and 330′.

In addition, when mounted, the operating lever 340 passes through the lever through slot 127 and the lever guide hole 314 and is fixed to the operating plate 320.

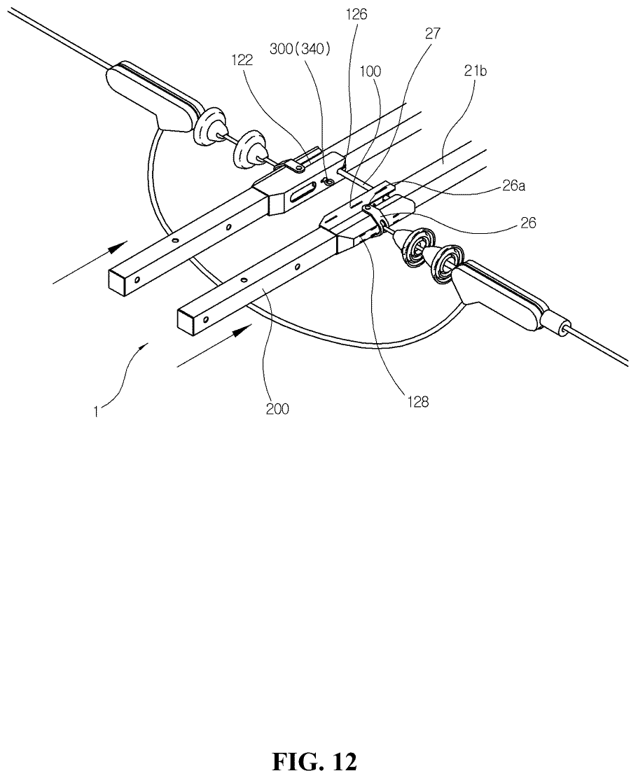

Accordingly, when the configuration of the coupling part 100 as described above is applied to the coupling part 120 for a built-in pole, as illustrated in FIG. 12, the coupling part 120 for a built-in pole is coupled to the steel crossarm 21b for a built-in pole, and an end of the steel crossarm 21b for a built-in pole is horizontally inserted into the steel crossarm insertion space 121 of the coupling part 120 for a built-in pole.

In this case, a cotter pin 26a of the bolt shackle 26 is accommodated in and guided by the pin guide grooves 122 formed at upper and lower portions of the coupling part 120 for a built-in pole, and the inclined reinforcement part 128 formed on the other side surface is inserted into and supported by an inner side of the bolt shackle 26. An M-bolt 27 that connects steel crossarms for built-in poles 21b on both sides is accommodated in the bolt guide groove 123 and the bolt guiding groove 126, thereby allowing installation without interference with the bolt shackle 26 and the M-bolt 27.

Therefore, the extension arm 1 of a steel crossarm for indirect live-line work of the present invention may be coupled to the steel crossarm 21b for a built-in pole through the coupling part 120 for a built-in pole. Through this coupling, the extension part 200 protrudes horizontally, thereby enabling extension of a length of the steel crossarm 21b for a built-in pole.

Meanwhile, when the coupling part 120 for a built-in pole is coupled and the mounting means 300 is fastened and fixed, as described above, the cotter pin 26a may be hooked, fastened, and fixed to the fasteners 330 and 330′ through expansion or folding of the fasteners 330 and 330′ by operating the operating lever 340 using a live-line work stick.

In addition, the coupling part 100 according to the third embodiment may include a coupling part 130 for a single built-in pole applicable to a steel crossarm for a single built-in pole of a distribution line.

To this end, referring to FIGS. 5 and 6, the coupling part 130 for a single built-in pole is configured to have a diameter smaller than a diameter of the steel crossarm for a single built-in pole so as to be insertable into the steel crossarm for a single built-in pole.

Further, the coupling part for a single built-in pole includes a pair of pin guide grooves 131 cut to open forward and formed at centers of upper and lower surfaces thereof to guide a cotter pin of a bolt shackle (not illustrated) for installing a suspension insulator on the steel crossarm for a single built-in pole.

Further, the coupling part for a single built-in pole includes a lever through slot 132 formed through an upper surface thereof at a rear side of the pin guide grooves 131 corresponding to the lever guide hole 314.

Accordingly, the mounting means 300 is configured such that, when mounted, the support plate 310 is fixed to an inner upper portion of the coupling part 130 for a single built-in pole so that the fasteners 330 and 330′ are positioned forward, and one end of the opening spring 332 is elastically installed at a rear side of the fasteners 330 and 330′ and the other end is supported by a side surface of the coupling part 130 for a single built-in pole, thereby providing an elastic force for expanding the fasteners 330 and 330′.

In addition, when mounted, the operating lever 340 passes through the lever through slot 132 and the lever guide hole 314 and is fixed to the operating plate 320.

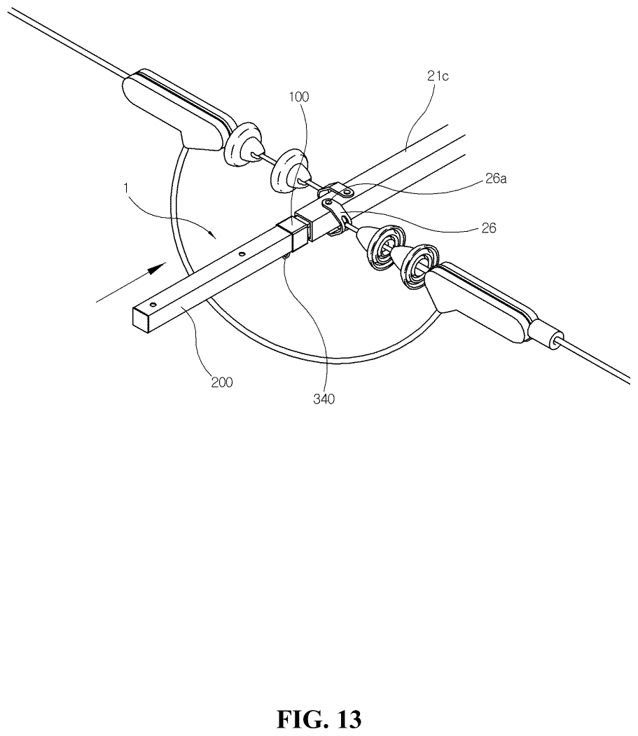

Accordingly, when the configuration of the coupling part 100 as described above is applied to the coupling part 130 for a single built-in pole, as illustrated in FIG. 13, the coupling part 130 for a single built-in pole is coupled to the steel crossarm 21c for a single built-in pole, and the coupling part 130 for a single built-in pole is horizontally inserted into an end of the steel crossarm 21c for a single built-in pole.

In this case, the cotter pin 26a of the bolt shackle 26 is accommodated in and guided by the pin guide grooves 131 formed at upper and lower portions of the coupling part 130 for a single built-in pole.

Therefore, the extension arm 1 of a steel crossarm for indirect live-line work of the present invention may be coupled to the steel crossarm 21c for a single built-in pole through the coupling part 130 for a single built-in pole. Through this coupling, the extension part 200 protrudes horizontally, thereby enabling extension of a length of the steel crossarm 21c for a single built-in pole.

Meanwhile, when the coupling part 130 for a single built-in pole is coupled and the mounting means 300 is fastened and fixed, as described above, the cotter pin 26a may be hooked, fastened, and fixed to the fasteners 330 and 330′ through expansion or folding of the fasteners 330 and 330′ by operating the operating lever 340 using a live-line work stick.

In this case, when the coupling part 130 for a single built-in pole is used for extension in the present invention, it is preferable that the extension work is performed in a state in which the operating lever 340 faces downward, since the live-line work stick may be easily manipulated.

Hereinafter, a method for securing a safety distance for indirect live-line work using the extension arm of a steel crossarm of the present invention having the above-described configuration will be described.

The method for securing a safety distance for indirect live-line work using an extension arm of a steel crossarm of the present invention performs indirect live-line work on extra-high-voltage distribution lines including one or more upper and lower circuits using the extension arm of a steel crossarm for indirect live-line work.

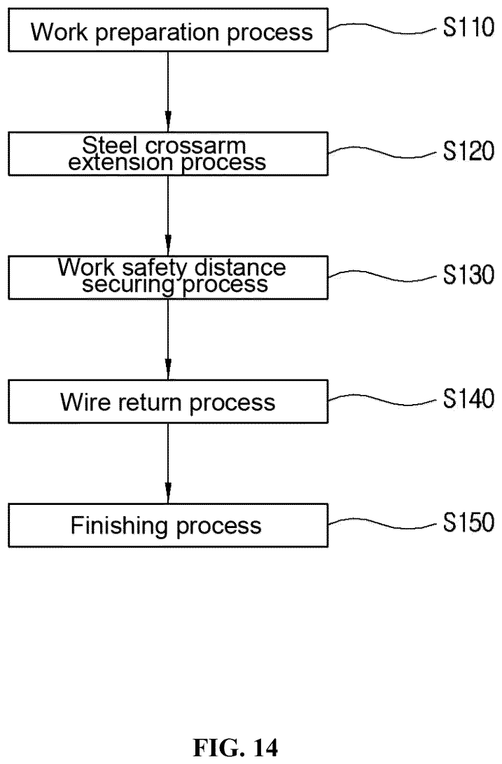

FIG. 14 is a flowchart illustrating an overall process of the method for securing a safety distance for indirect live-line work using an extension arm of a steel crossarm of the present invention.

As illustrated in FIG. 14, the method for securing a safety distance for indirect live-line work using an extension arm of a steel crossarm of the present invention performs indirect live-line work on extra-high-voltage distribution lines including one or more upper and lower circuits using the extension arm of a steel crossarm for indirect live-line work, and the method includes: a work preparation process S110, a steel crossarm extension process S120, a work safety distance securing process S130, a wire return process S140, and a finishing process S150. By sequentially performing these processes, it is possible to secure a safety distance for indirect live-line work for extra-high-voltage distribution lines including one or more upper and lower circuits.

First, the work preparation process S110 is performed.

In performing the method for securing a safety distance for indirect live-line work using an extension arm of a steel crossarm of the present invention, a worker carries necessary live-line work equipment and moves to a distribution line.

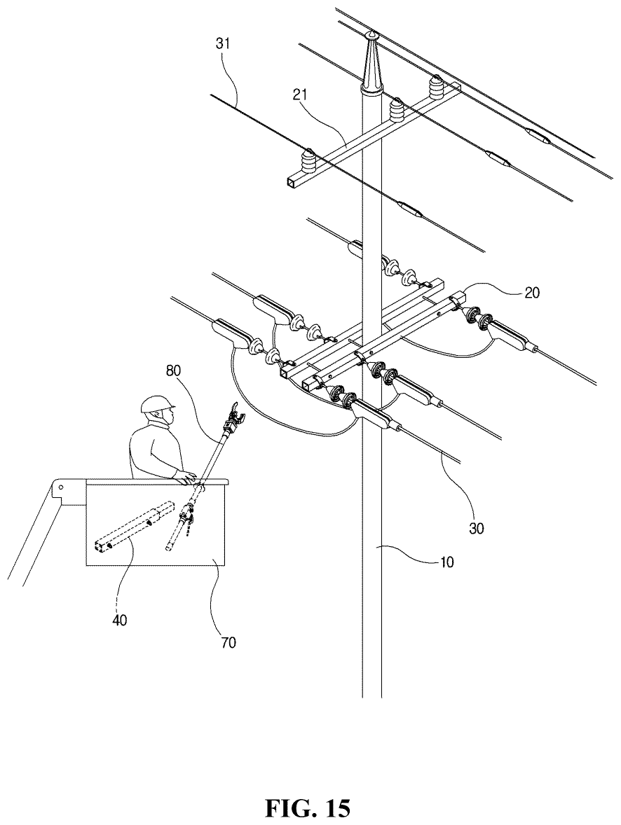

Referring to FIG. 15, in the present invention, the worker carries live-line work equipment, such as the extension arm 1 of a steel crossarm for indirect live-line work for extending a steel crossarm, including a conventional live-line work stick 80, and moves to a distribution line to be worked on using a live-line bucket 70.

Thereafter, the steel crossarm extension process S120 is performed.

In performing the method for securing a safety distance for indirect live-line work using an extension arm of a steel crossarm of the present invention, the steel crossarm 20 of a distribution line formed on the utility pole 10 is extended.

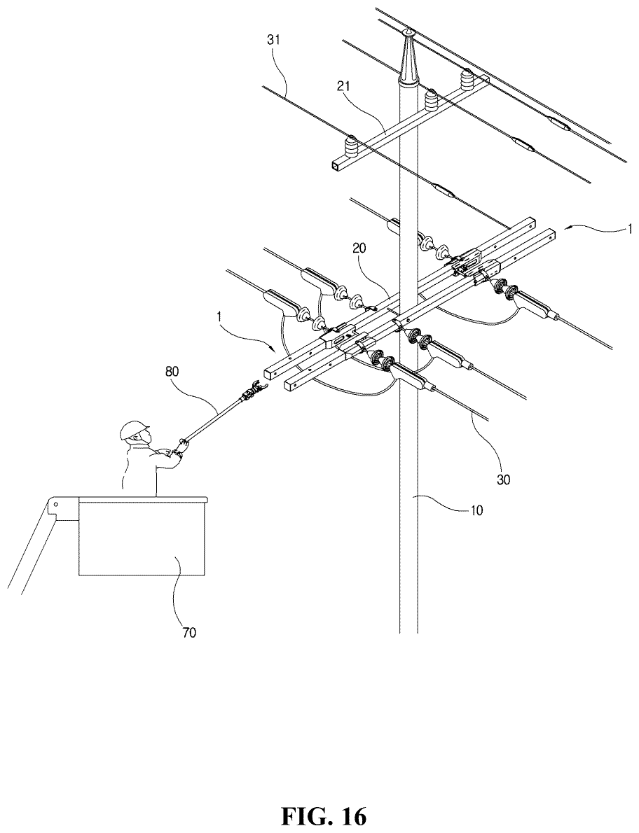

Referring to FIG. 16, the live-line work stick 80 and live-line work equipment are used to couple the extension arm 1 of a steel crossarm for indirect live-line work to one side of the steel crossarm 20 of the distribution line by indirect live-line work. Accordingly, a length of one side of the steel crossarm 20 is extended.

Meanwhile, the steel crossarm 20 of the distribution line applied in the present invention may be a steel crossarm for a pin-type pole, a built-in pole, or a single built-in pole according to a type of pole, as illustrated in FIGS. 11 to 13.

Thereafter, the safety distance securing process S130 is performed.

In performing the method for securing a safety distance for indirect live-line work using an extension arm of a steel crossarm of the present invention, the wires 30 of the distribution line are moved to secure a safety distance for indirect live-line work on the distribution line.

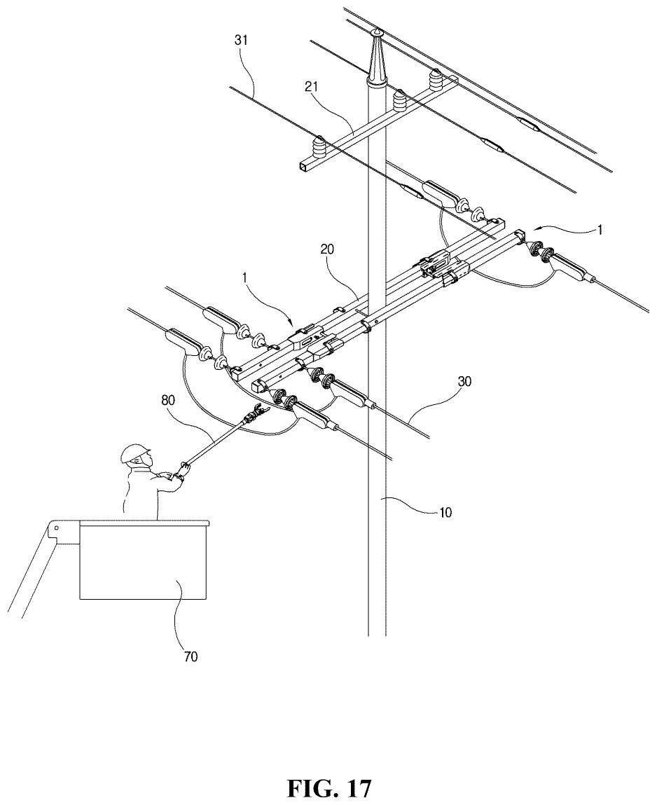

Referring to FIG. 17, a wire 30 fixed to the steel crossarm 20 may be separated by indirect live-line work using the live-line work stick 80 or the like and moved back to and fixed to the extension arm 1 of a steel crossarm for indirect live-line work.

Accordingly, a safety distance for indirect live-line work is secured at a location of the wire 30 moved as described above.

Thereafter, the wire return process S140 is performed.

In performing the method for securing a safety distance for indirect live-line work using an extension arm of a steel crossarm of the present invention, the wire 30 of the distribution line, which has been moved to the extension arm 1 of a steel crossarm for indirect live-line work, is moved back to the steel crossarm 20.

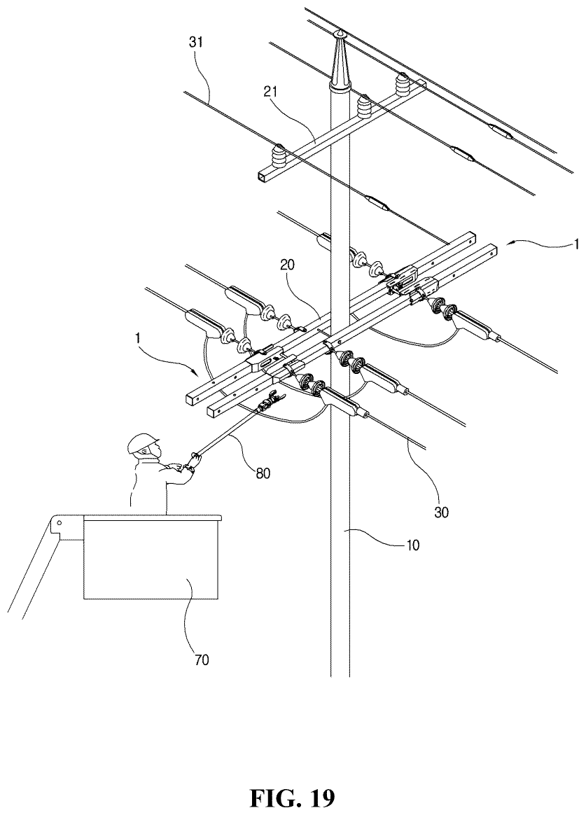

Referring to FIG. 19, the wire 30 fixed to the extension arm 1 of a steel crossarm for indirect live-line work may be separated by indirect live-line work using the live-line work stick 80 and live-line work equipment and moved back to and fixed to the steel crossarm 20.

Thereafter, the finishing process S150 is performed.

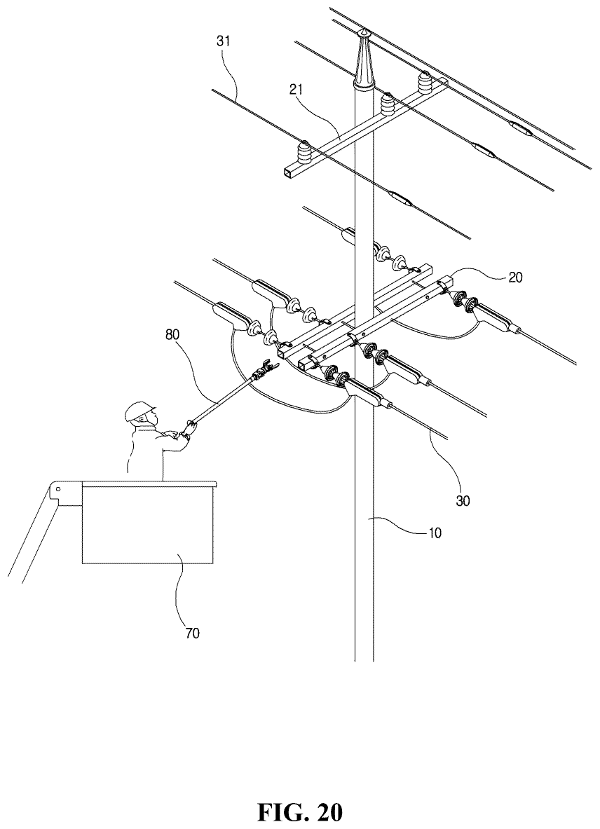

In performing the method for securing a safety distance for indirect live-line work using an extension arm of a steel crossarm of the present invention, referring to FIG. 20, after the wire 30 is returned as described above, live-line work equipment, such as the extension arm 1 of a steel crossarm for indirect live-line work, may be removed by indirect live-line work using the live-line work stick 80 and live-line work equipment.

Therefore, in the method for securing a safety distance for indirect live-line work using an extension arm of a steel crossarm of the present invention, a safety distance for indirect live-line work may be secured on the distribution line.

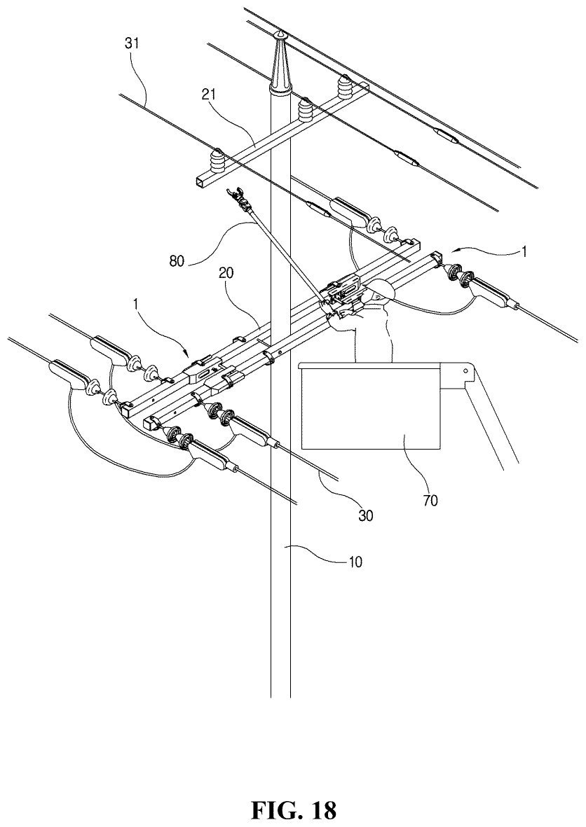

Meanwhile, in the method for securing a safety distance for indirect live-line work using an extension arm of a steel crossarm of the present invention, a safety distance for indirect live-line work for typical indirect live-line uninterruptible power distribution construction is secured at a location of the wire 30 of the distribution line moved through the work safety distance securing process S130 described above. Referring to FIG. 18, work on the distribution line may be performed through the safety distance for indirect live-line work. For example, various operations may be performed by indirect live-line work, such as utility pole replacement, steel crossarm replacement, suspension insulator replacement, LP insulator replacement, angle adjustment, installation and removal of an LA, sub-pole installation, protective device installation and removal, jumper wire replacement, wire replacement, line inspection by type, and switch installation and removal.

In addition, an indirect live-line uninterruptible power distribution method based on the method for securing a safety distance for indirect live-line work using the extension arm of a steel crossarm having the above-described configuration will be described.

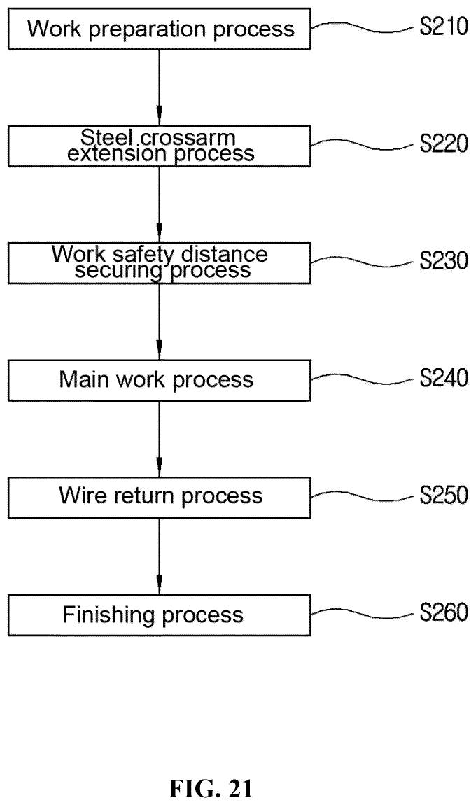

FIG. 21 is a flowchart illustrating an overall process of the indirect live-line uninterruptible power distribution method based on the method for securing a safety distance for indirect live-line work using an extension arm of a steel crossarm of the present invention.

As illustrated in FIG. 21, the indirect live-line uninterruptible power distribution method based on the method for securing a safety distance for indirect live-line work using an extension arm of a steel crossarm of the present invention performs indirect live-line work on extra-high-voltage distribution lines including one or more upper and lower circuits using the extension arm of a steel crossarm for indirect live-line work, and the method includes: a work preparation process S210, a steel crossarm extension process S220, a work safety distance securing process S230, a main work process S240, a wire return process S250, and a finishing process S260.

First, the work preparation process S210 is performed.

In performing the indirect live-line uninterruptible power distribution method based on the method for securing a safety distance for indirect live-line work using an extension arm of a steel crossarm of the present invention, a worker carries necessary live-line work equipment and moves to a distribution line.

Referring to FIG. 15, in the present invention, the worker carries live-line work equipment, such as the extension arm 1 of a steel crossarm for indirect live-line work for extending a steel crossarm, including the conventional live-line work stick 80, and moves to a distribution line to be worked on using the live-line bucket 70.

Thereafter, the steel crossarm extension process S220 is performed.

In performing the indirect live-line uninterruptible power distribution method based on the method for securing a safety distance for indirect live-line work using an extension arm of a steel crossarm of the present invention, the steel crossarm 20 of a distribution line formed on the utility pole 10 is extended.

Referring to FIG. 16, the live-line work stick 80 and live-line work equipment are used to couple the extension arm 1 of a steel crossarm for indirect live-line work to one side of the steel crossarm 20 of the distribution line by indirect live-line work. Accordingly, a length of one side of the steel crossarm 20 is extended.

Meanwhile, the steel crossarm 20 of the distribution line applied in the present invention may be a steel crossarm for a pin-type pole, a built-in pole, or a single built-in pole according to a type of pole, as illustrated in FIGS. 11 to 13.

Thereafter, the safety distance securing process S230 is performed.

In performing the indirect live-line uninterruptible power distribution method based on the method for securing a safety distance for indirect live-line work using an extension arm of a steel crossarm of the present invention, the wires 30 of the distribution line are moved to secure a safety distance for indirect live-line work on the distribution line.

Referring to FIG. 17, a wire 30 fixed to the steel crossarm 20 may be separated by indirect live-line work using the live-line work stick 80 or the like and moved back to and fixed to the extension arm 1 of a steel crossarm for indirect live-line work.

Accordingly, a safety distance for indirect live-line work is secured at a location of the wires 30 moved as described above.

Thereafter, the main work process S240 is performed.

In performing the indirect live-line uninterruptible power distribution method based on the method for securing a safety distance for indirect live-line work using an extension arm of a steel crossarm of the present invention, indirect live-line work is performed on a distribution line.

Referring to FIG. 18, to perform main work on distribution lines including one or more circuits according to the present invention, a worker enters in a state of being separated by the secured safety distance for indirect live-line work using the live-line bucket 70, and then may perform the main work on the distribution line using live-line work equipment such as the live-line work stick 80.

Thereafter, the wire return process S250 is performed.

In performing the indirect live-line uninterruptible power distribution method based on the method for securing a safety distance for indirect live-line work using an extension arm of a steel crossarm of the present invention, when the main work is completed as described above, the wire 30 of the distribution line, which has been moved to the extension arm 1 of a steel crossarm for indirect live-line work, is moved back to the steel crossarm 20.

Referring to FIG. 19, the wire 30 fixed to the extension arm 1 of a steel crossarm for indirect live-line work may be separated by indirect live-line work using the live-line work stick 80 and live-line work equipment and moved back to and fixed to the steel crossarm 20.

Thereafter, the finishing process S260 is performed.

In performing the indirect live-line uninterruptible power distribution method based on the method for securing a safety distance for indirect live-line work using an extension arm of a steel crossarm of the present invention, referring to FIG. 20, after the wire 30 is returned as described above, live-line work equipment, such as the extension arm 1 of a steel crossarm for indirect live-line work, may be removed by indirect live-line work using the live-line work stick 80 and live-line work equipment.

Accordingly, in the indirect live-line uninterruptible power distribution method based on the method for securing a safety distance for indirect live-line work using an extension arm of a steel crossarm of the present invention, when work is performed for distribution lines including one or more upper and lower circuits, a safety distance for indirect live-line work is secured on the distribution line, and the live-line bucket 70 enters in a state of being separated by the secured safety distance. In this state, the work may be performed by indirect live-line work.

Meanwhile, the indirect live-line uninterruptible power distribution method based on the method for securing a safety distance for indirect live-line work using an extension arm of a steel crossarm of the present invention is not limited to the work performed in the main work process S240, and various operations may be performed. For example, various operations may be performed by indirect live-line work, such as utility pole replacement, steel crossarm replacement, suspension insulator replacement, LP insulator replacement, angle adjustment, installation and removal of an LA, sub-pole installation, protective device installation and removal, jumper wire replacement, wire replacement, line inspection by type, and switch installation and removal.

Hereinafter, examples of various operations will be described.

First, the main work process S240 of the present invention may perform a pole replacement operation of replacing a pin-type pole of an existing upper distribution line with a built-in pole.

In this case, the pole replacement operation is performed as follows.

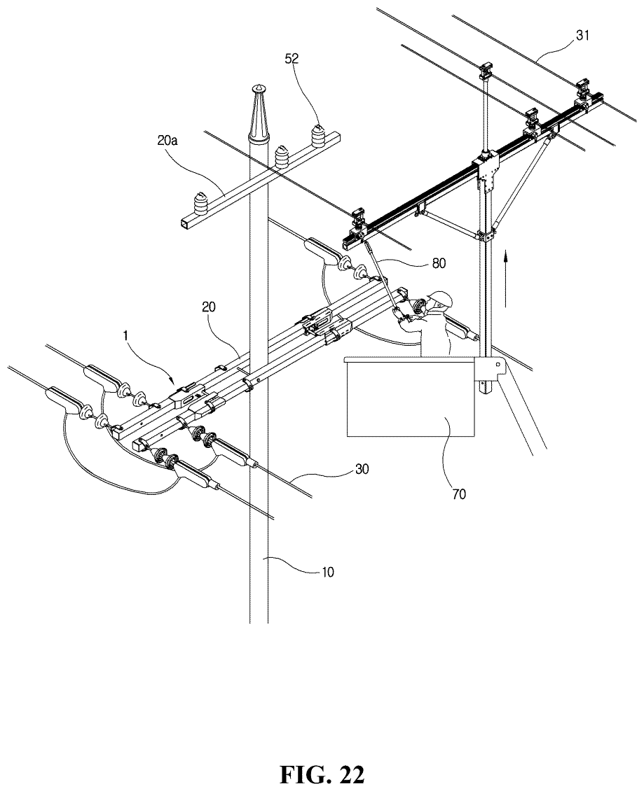

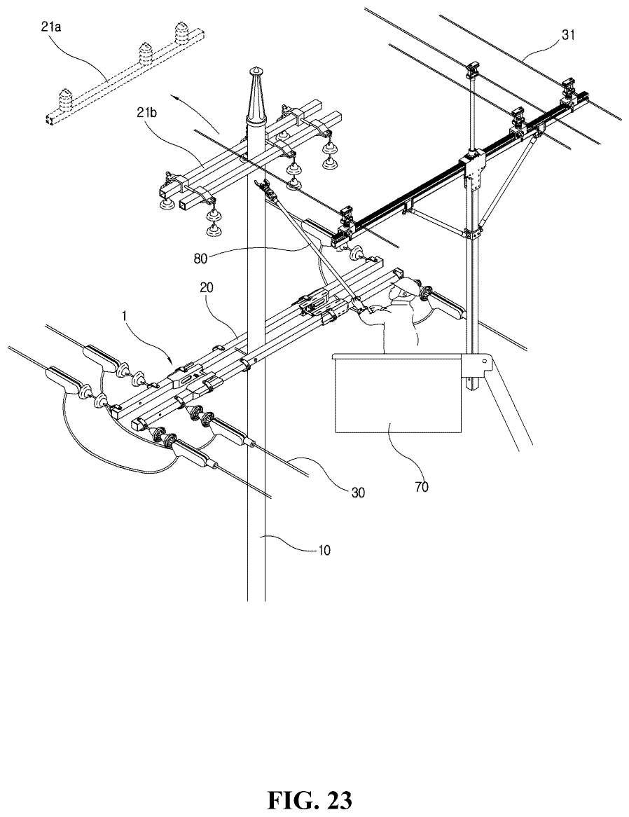

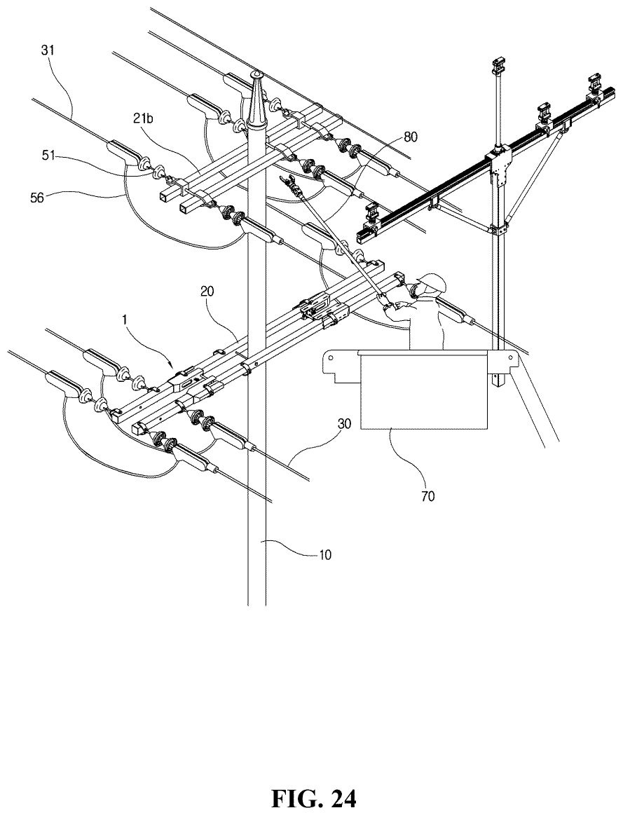

Referring to FIGS. 22 to 24, first, after a safety distance for indirect live-line work on a lower distribution line is secured, the upper distribution line is accessed using the live-line bucket 70.

Thereafter, the wires 31 of the upper distribution line are separated from the LP insulator 52. In this case, when the wires 31 are separated as described above, the wires 31 to be separated may be separated using a conventional indirect live-line lift arm or the like.

Thereafter, the steel crossarm 21a for a pin-type pole installed on the utility pole 10 is removed by indirect live-line work using live-line work equipment such as a conventional live-line work stick, and a new steel crossarm 21b for a built-in pole is installed in the removed location.

Thereafter, the separated wires 31 are installed on the steel crossarm 21b for a built-in pole. That is, after conventional wire tensioners (not illustrated) are symmetrically installed on both sides of the installed steel crossarm 21b for a built-in pole, the wires 31 are held by the wire tensioners, and then the wires 31 are fixed to the suspension insulator 51 formed on the steel crossarm 21b for a built-in pole.

Accordingly, in the main work process S240 of the present invention, as described above, after a safety distance for indirect live-line work on the lower distribution line is secured, the worker may safely access the upper distribution line and perform the pole replacement operation of the upper distribution line.

Further, in the present invention, the main work process S240 may perform a steel crossarm replacement operation of replacing a steel crossarm with a new steel crossarm in the case of a pin-type pole of an existing upper distribution line.

In this case, the steel crossarm replacement operation is performed as follows.

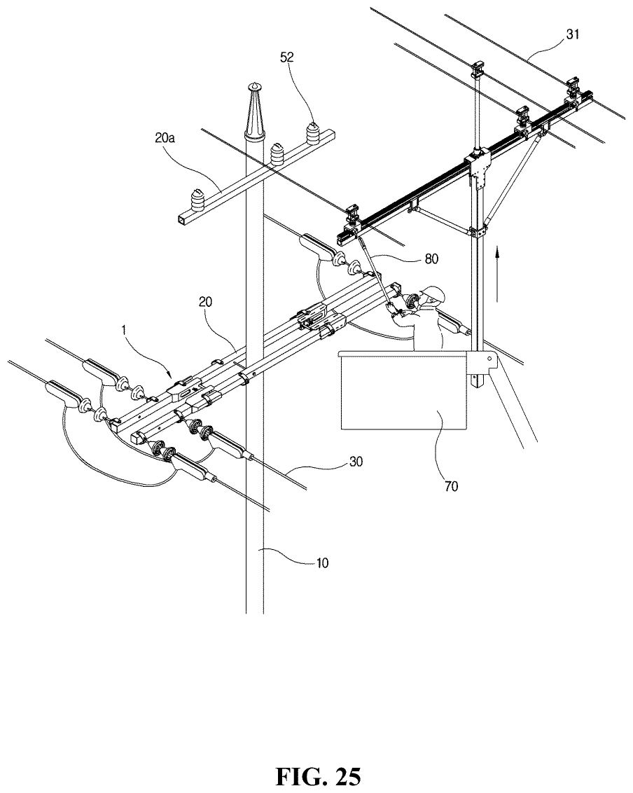

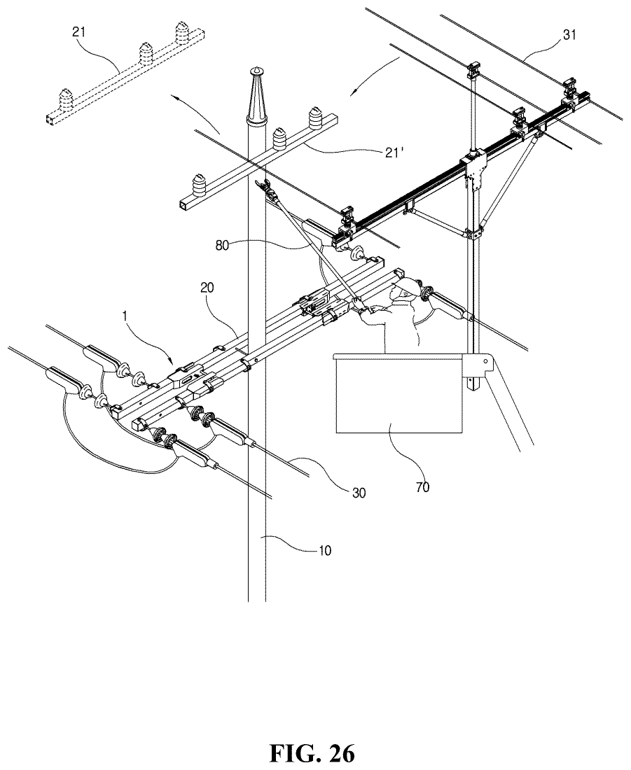

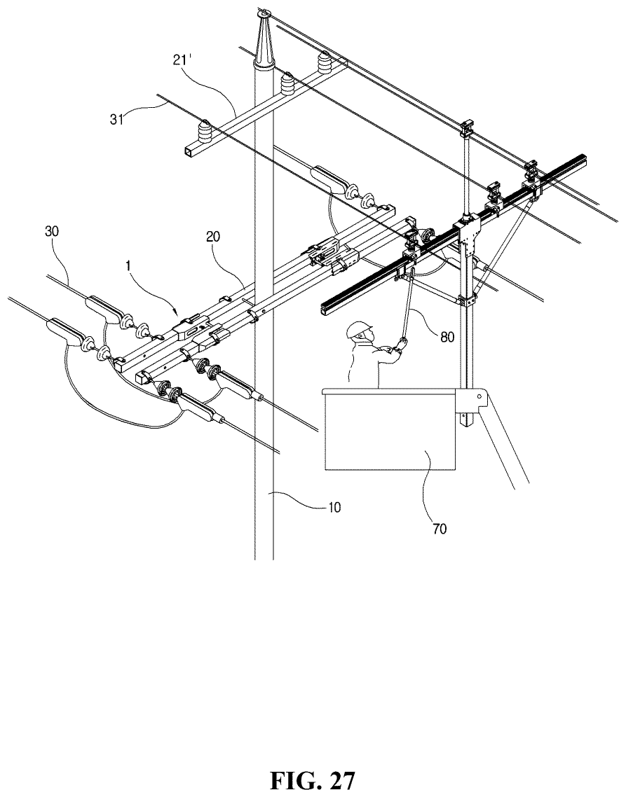

Referring to FIGS. 25 to 27, first, after a safety distance for indirect live-line work on a lower distribution line is secured, the upper distribution line is accessed using the live-line bucket 70.

Thereafter, the wires 31 of the upper distribution line are separated from the LP insulator 52 and the existing steel crossarm 21. In this case, when the wires 31 are separated as described above, the wires 31 to be separated may be separated using the conventional indirect live-line lift arm or the like.

Thereafter, the existing steel crossarm 21 installed on the utility pole 10 is removed by indirect live-line work using live-line work equipment such as a conventional live-line work stick, and a new steel crossarm 21′ is installed in the removed location.

Thereafter, the separated wires 31 may be installed on the new steel crossarm 21′. Thereafter, the wires may be seated on and fixed to the LP insulator 52.

Accordingly, in the main work process S240 of the present invention, as described above, after a safety distance for indirect live-line work on the lower distribution line is secured, the worker may safely access the upper distribution line and perform the steel crossarm replacement operation of the upper distribution line.

Further, in the present invention, the main work process S240 may perform a suspension insulator replacement operation of replacing a suspension insulator of an existing upper distribution line.

In this case, the suspension insulator replacement operation is performed as follows.

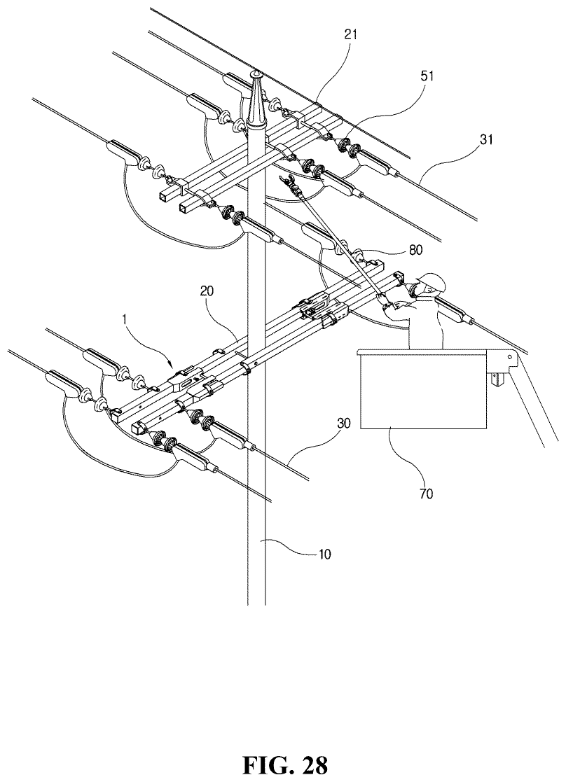

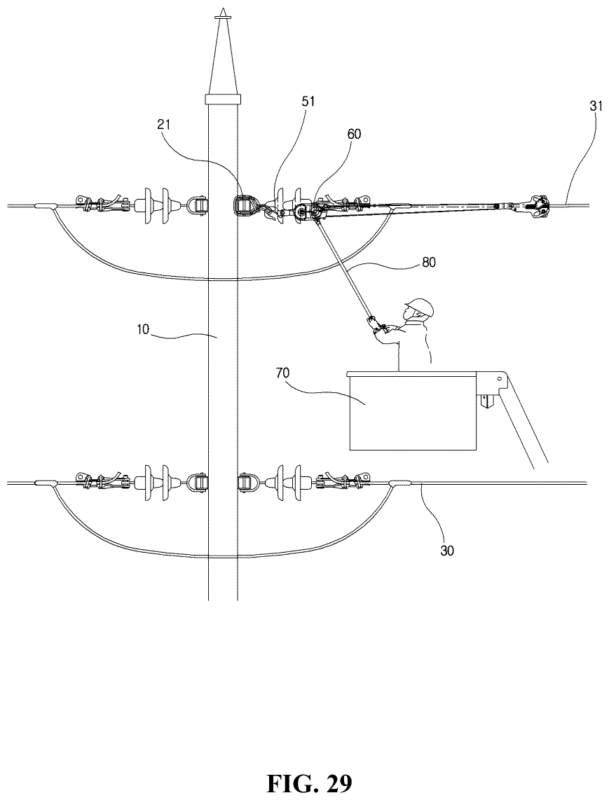

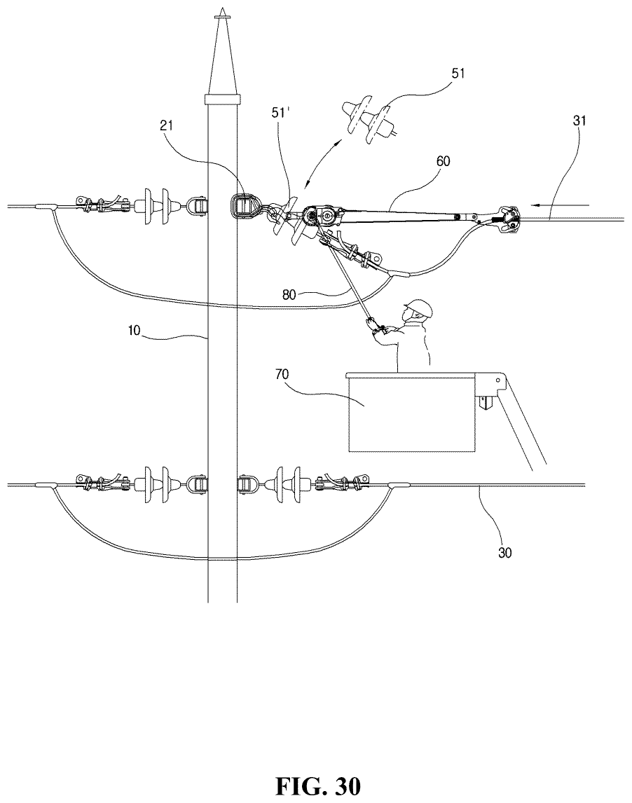

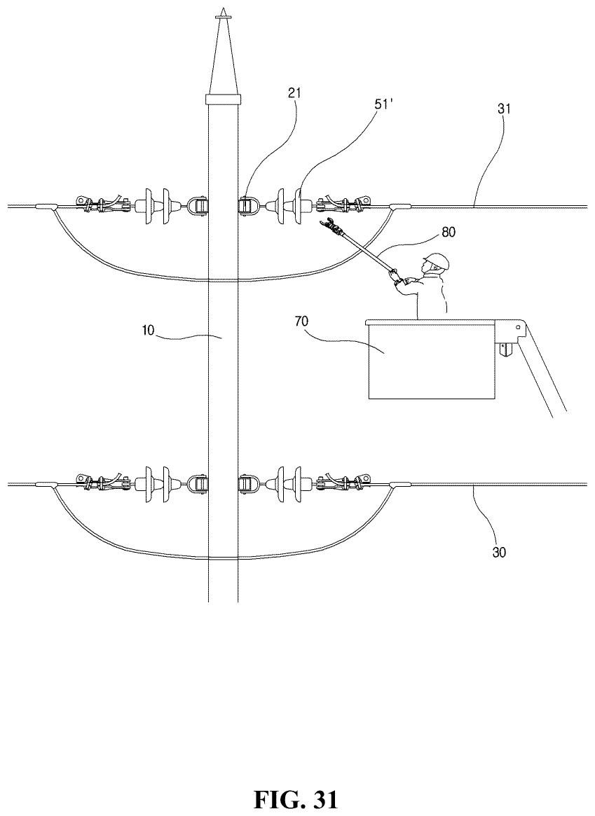

Referring to FIGS. 28 to 31, first, after a safety distance for indirect live-line work on a lower distribution line is secured, the upper distribution line is accessed using the live-line bucket 70.

Thereafter, wire tensioners 60 are installed on the steel crossarm 21 of the upper distribution line. The wire tensioners 60 are symmetrically installed on both sides of the steel crossarm 21 in a longitudinal direction of the wires 31, and the wires 31 are held and fixed using the installed wire tensioners 60.

Thereafter, the suspension insulator 51 is removed, and the wires 31 are pulled using the wire tensioners 60, thereby releasing tension applied to the suspension insulator 51 that connects the steel crossarm 21 and the wires 31, that is, placing the suspension insulator 51 in a no-tension state.

Thereafter, when the suspension insulator 51 is replaced, the existing suspension insulator 51 is separated from and removed from the steel crossarm 21 and the wires 31, and a new suspension insulator 51′ is connected at the removed location.

Thereafter, the wire tensioners 60 pulling the wires 31 are released to apply tension to the wires 31, and then the wire tensioners 60 are separated from and removed from the steel crossarm 21 and the wires 31.

Accordingly, in the main work process S240 of the present invention, as described above, after a safety distance for indirect live-line work on the lower distribution line is secured, the worker may safely access the upper distribution line and perform the suspension insulator replacement operation of the upper distribution line.

Further, in the present invention, the main work process S240 may perform an LP insulator replacement operation of replacing an LP insulator of an existing upper distribution line.

In this case, the LP insulator replacement operation is performed as follows.

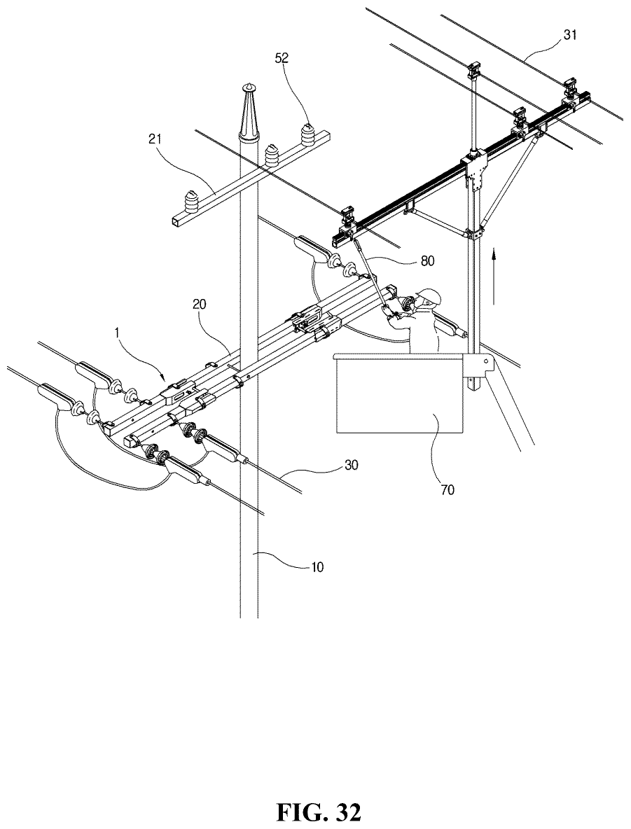

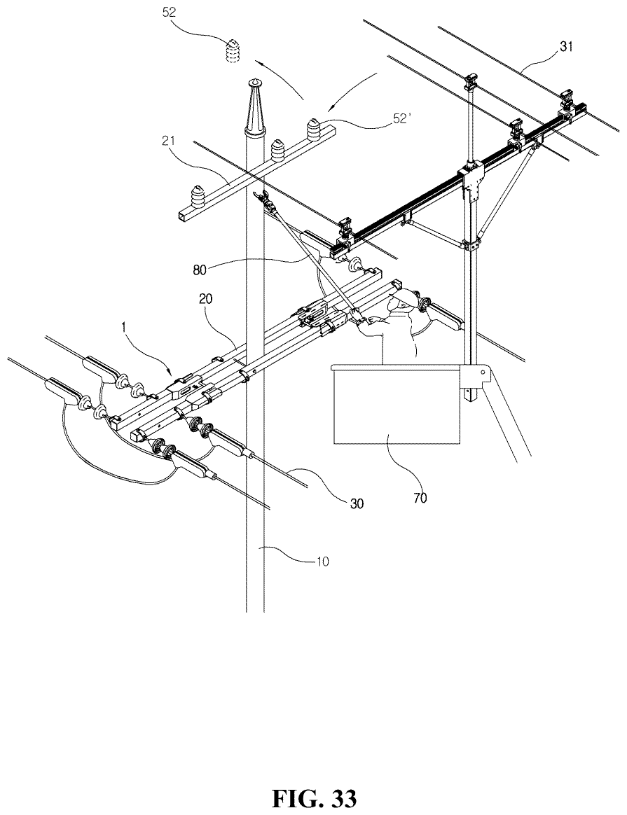

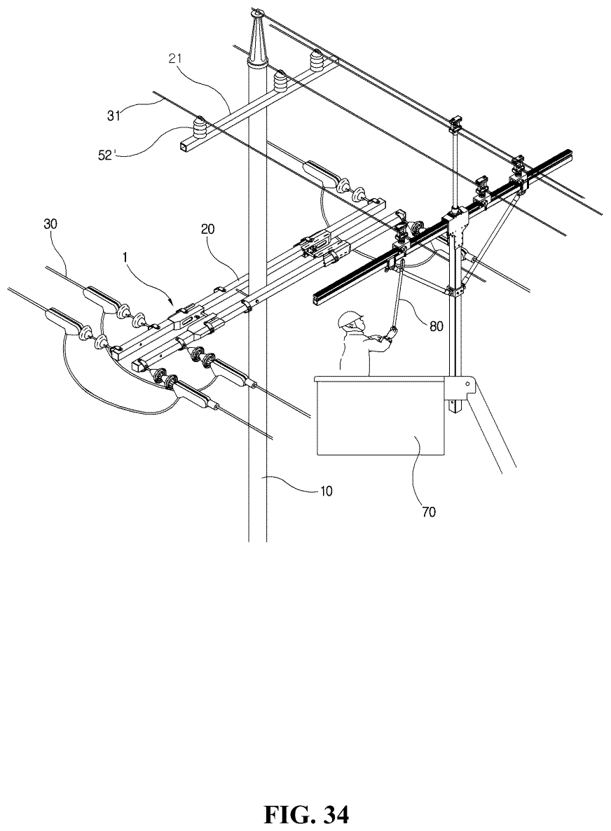

Referring to FIGS. 32 to 34, first, after a safety distance for indirect live-line work on a lower distribution line is secured, the upper distribution line is accessed using the live-line bucket 70.

Thereafter, the wires 31 of the upper distribution line are separated from the existing LP insulator 52. In this case, when the wires 31 are separated as described above, the wires 31 to be separated may be separated using the conventional indirect live-line lift arm or the like.

Thereafter, using conventional live-line work equipment, such as a stick, the existing LP insulator 52 installed on the steel crossarm 21 through indirect live-line work is separated and removed, and a new LP insulator 52′ is installed in the removed location.

Thereafter, the separated wires 31 may be installed in the new LP insulator 52′. Thereafter, the wires may be seated and fixed to the new LP insulator 52′.

Accordingly, in the main work process S240 of the present invention, as described above, after a safety distance for indirect live-line work on the lower distribution line is secured, the worker may safely access the upper distribution line and perform the LP insulator replacement operation of the upper distribution line.

Further, in the present invention, the main work process S240 may perform an angle adjustment operation of adjusting an angle of the wires of an existing upper distribution line.

In this case, the angle adjustment operation is performed as follows.

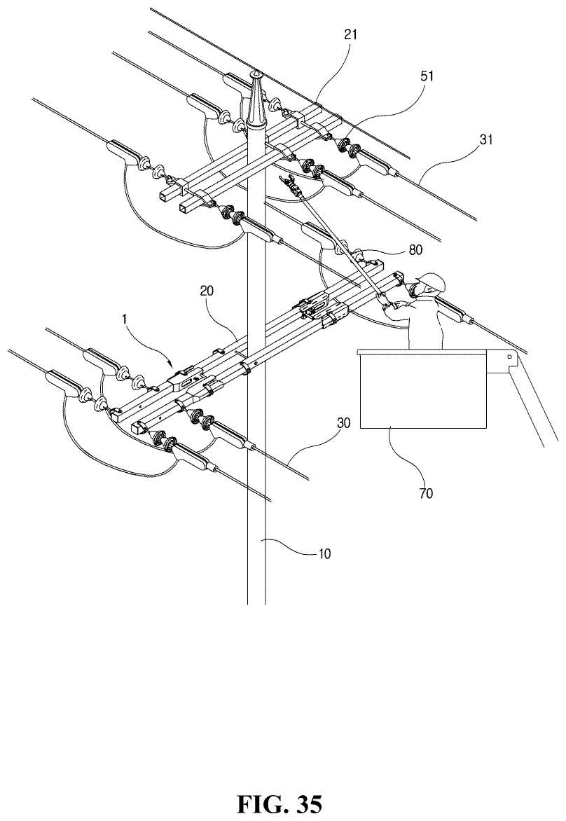

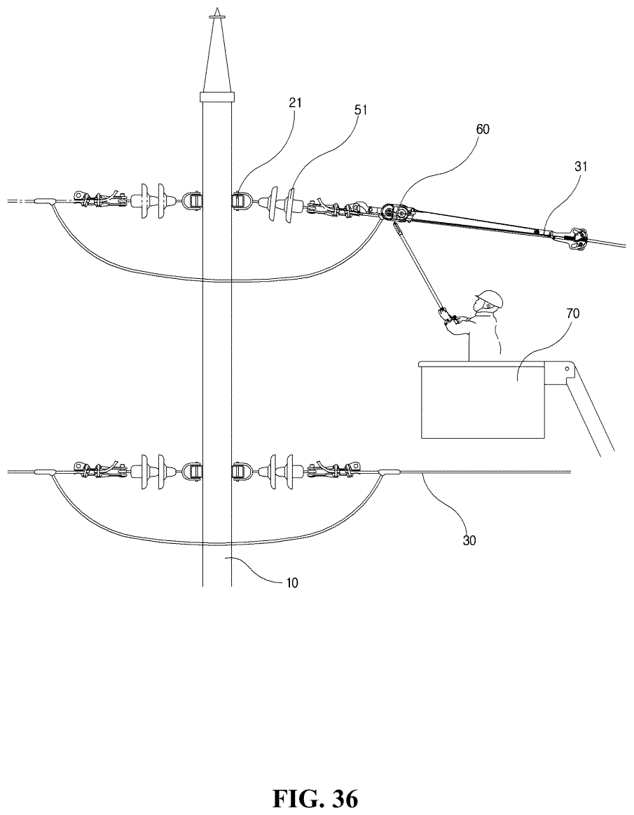

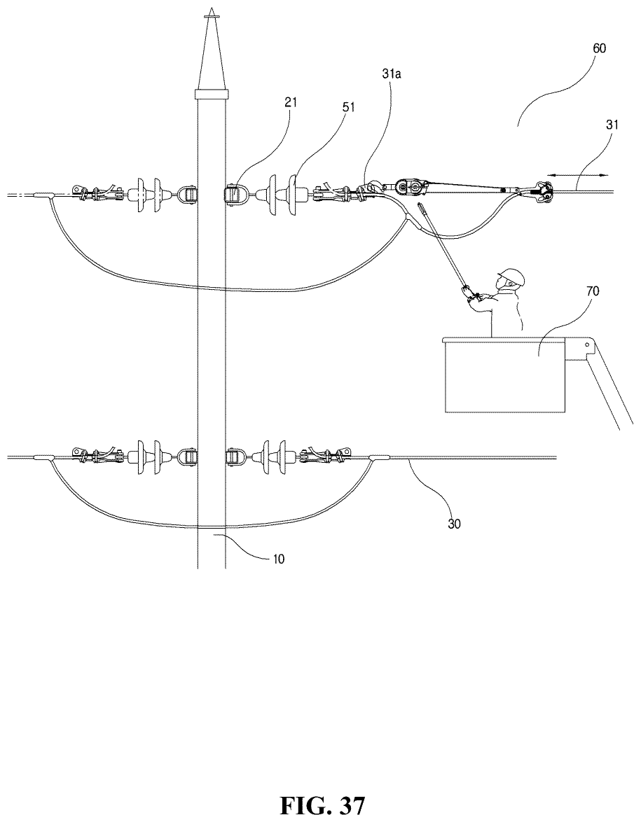

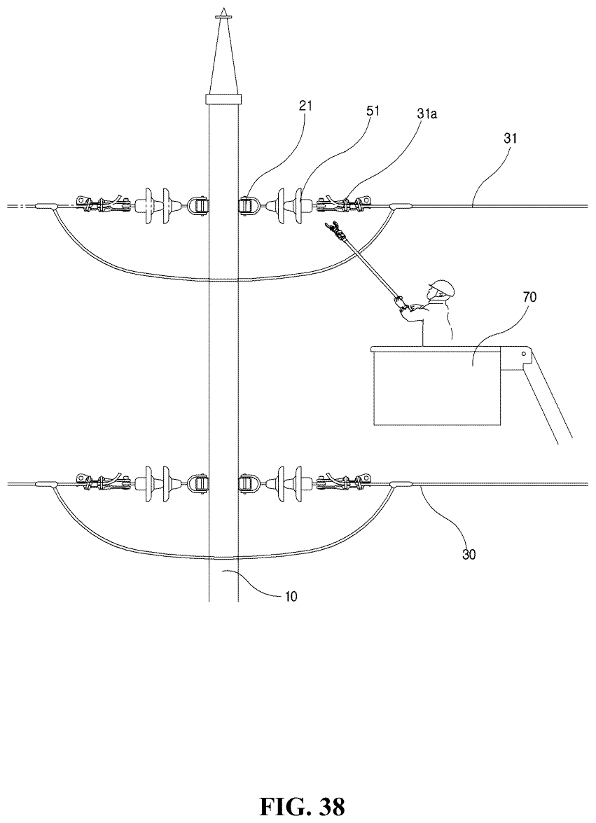

Referring to FIGS. 35 to 38, first, after a safety distance for indirect live-line work on a lower distribution line is secured, the upper distribution line is accessed using the live-line bucket 70.

Thereafter, the wire tensioners 60 are installed on both sides of the steel crossarm 21 of the upper distribution line, and the wires 31 on both sides are held and fixed using the wire tensioners 60.

Thereafter, the wire tensioners 60 are operated to pull or release the wires, thereby adjusting an appropriate angle of the wires 31.

Thereafter, a dead-end clamp 31a of the wires 31 is separated, and the separated dead-end clamp 31a is reinstalled and connected at a location of the wires 31 whose angle has been adjusted.

Thereafter, the wire tensioners 60 pulling the wires 31 are released to apply tension to the wires 31 whose angle has been adjusted, and then the wire tensioners 60 are separated from and removed from the steel crossarm 21 and the wires 31.

Accordingly, in the main work process S240 of the present invention, as described above, after a safety distance for indirect live-line work on the lower distribution line is secured, the worker may safely access the upper distribution line and perform the angle adjustment operation of the upper distribution line.

Further, in the present invention, the main work process S240 may perform an LA installation operation of installing a new LA (lightning arrester) on an existing upper distribution line.

In this case, the LA installation operation is performed as follows.

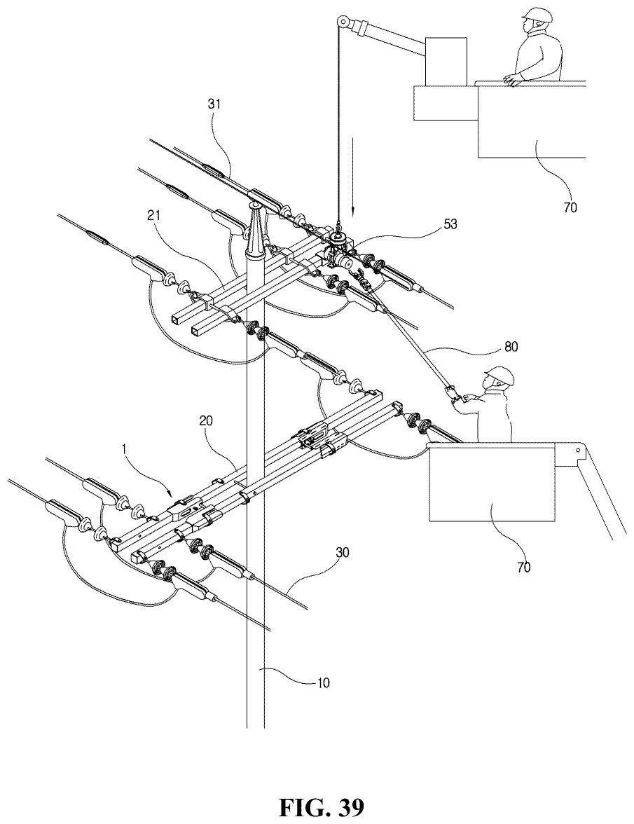

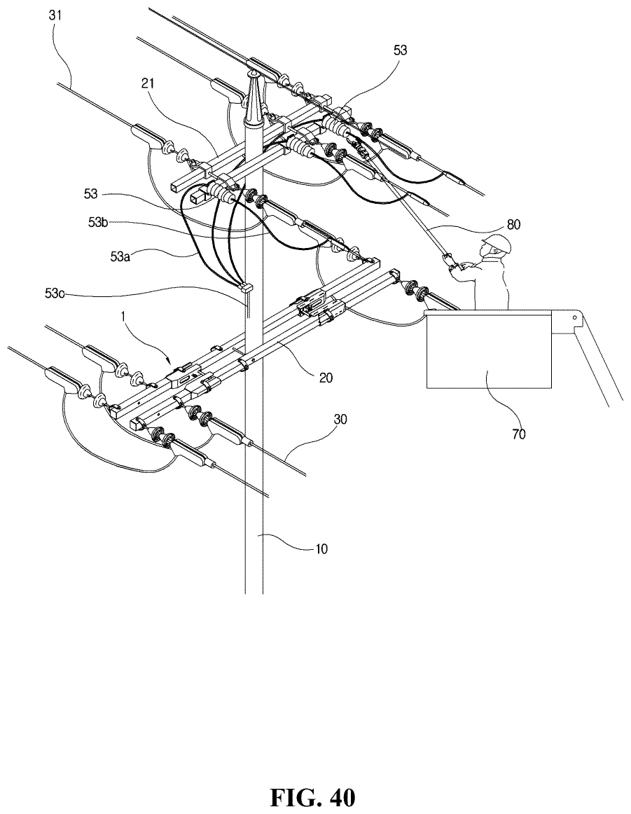

Referring to FIGS. 39 and 40, first, after a safety distance for indirect live-line work on a lower distribution line is secured, the upper distribution line is accessed using the live-line bucket 70.

Thereafter, an LA 53 is installed on the steel crossarm 21 of the upper distribution line. In this case, the LA 53 may be lowered from above using a winch of the live-line bucket 70 or the like to approach the steel crossarm 21 and installed by indirect live-line work using the live-line work stick 80 or the like.

Thereafter, a ground wire 53a of the installed LA 53 is connected to a pole ground wire 53c, and the ground wire 53a drawn from the LA 53 is connected to a ground terminal of the pole ground wire 53c installed on the utility pole 10.

Thereafter, a primary-side lead wire 53b of the installed LA 53 is connected. That is, insulation is stripped at a location of the wires 31 to which the primary-side lead wire 53b is to be connected, and then the primary-side lead wire 53b is compression-connected to the stripped portion.

Accordingly, in the main work process S240 of the present invention, as described above, after a safety distance for indirect live-line work on the lower distribution line is secured, the worker may safely access the upper distribution line and perform the LA installation operation of the upper distribution line.

Further, in the present invention, the main work process S240 may perform an LA removal operation of removing an existing LA (lightning arrester) installed on an existing upper distribution line.

In this case, the LA removal operation is performed as follows.

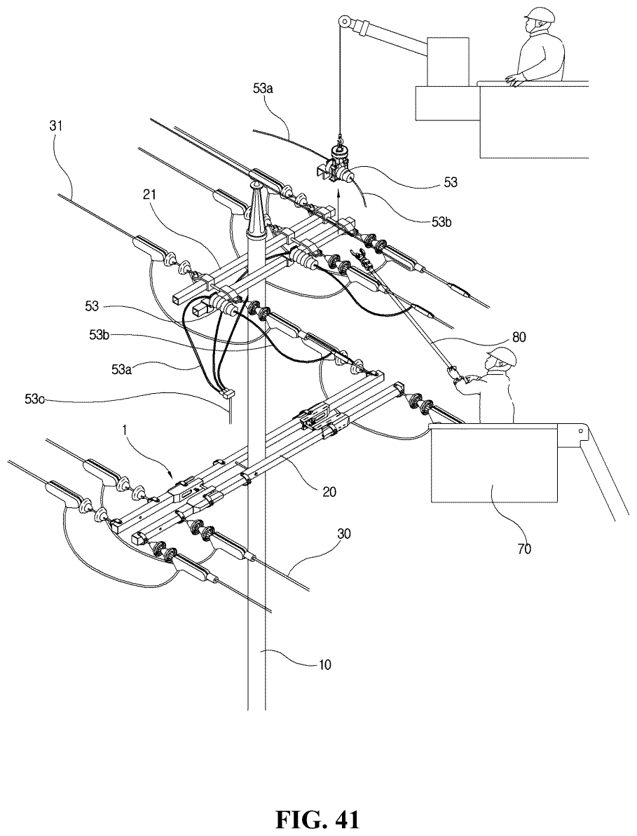

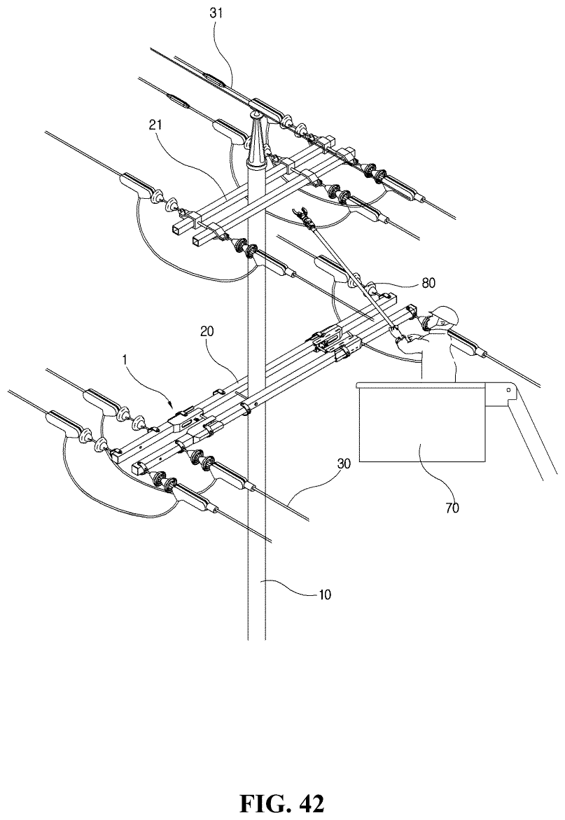

Referring to FIGS. 41 and 42, after a safety distance for indirect live-line work on a lower distribution line is secured, the upper distribution line is accessed using the live-line bucket 70.

Thereafter, the primary-side lead wire 53b that connects the existing LA 53 installed on the steel crossarm 21 of the upper distribution line and the wires 31 is separated and cut using a cutter of the live-line work stick 80 or the like.

Thereafter, the ground wire 53a connected to the pole ground wire 53c of the existing LA 53 installed on the steel crossarm 21 of the upper distribution line is separated, and then cut and separated using the cutter of the live-line work stick 80 or the like.

Thereafter, the existing LA 53 installed on the steel crossarm 21 of the upper distribution line is removed. That is, after bolts or nuts fixed to the steel crossarm 21 are loosened to release a fixing force of a bracket (not illustrated) on which the existing LA 53 is installed, the existing LA 53 is lifted and removed using a winch of the live-line bucket 70 or the like.

Accordingly, in the main work process S240 of the present invention, as described above, after a safety distance for indirect live-line work on the lower distribution line is secured, the worker may safely access the upper distribution line and perform the LA removal operation of the upper distribution line.

Further, in the present invention, the main work process S240 may perform a sub-pole installation operation of newly installing a sub-pole between utility poles to install existing distribution lines including one or more circuits.

In this case, the sub-pole installation operation is performed as follows.

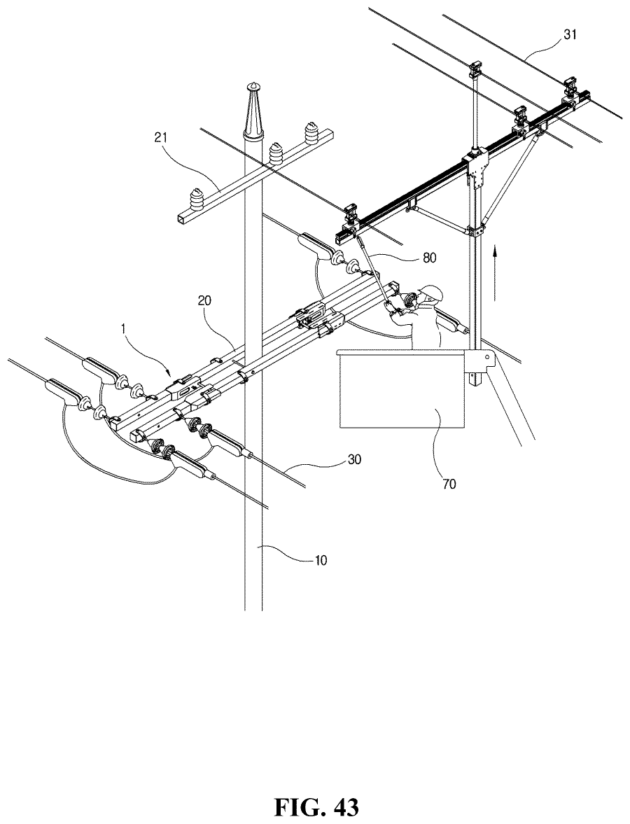

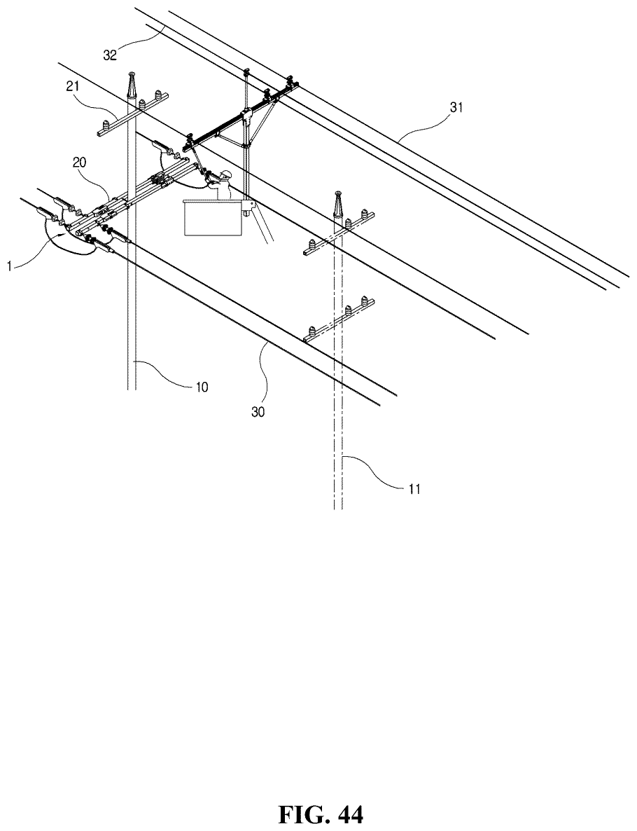

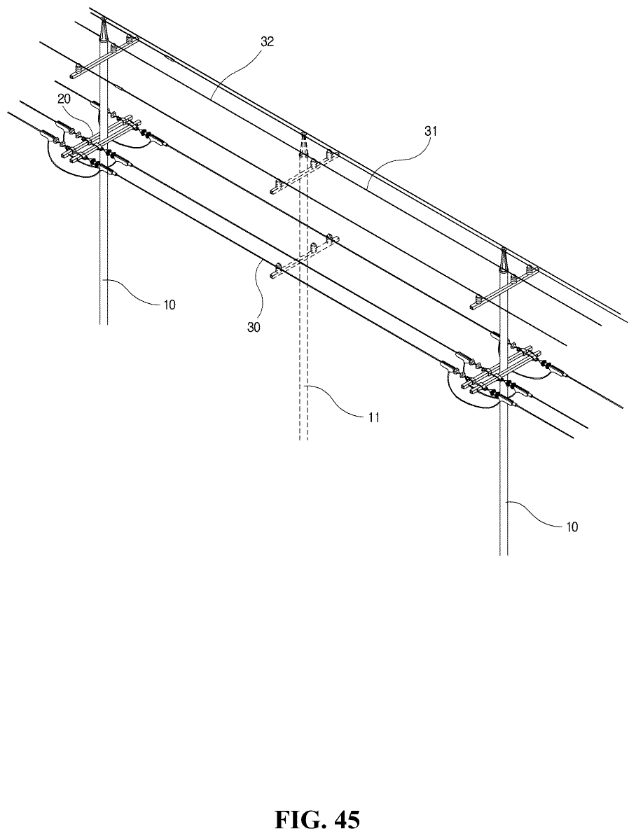

Referring to FIGS. 43 to 45, first, after a safety distance for indirect live-line work on a lower distribution line is secured, the upper distribution line is accessed using the live-line bucket 70.

Thereafter, the wires 31 and an overhead ground wire 32 of the upper distribution line are separated, and the wires 31 and the overhead ground wire 32 are lifted upward and moved to a safe location using the conventional indirect live-line lift arm or the like.

Thereafter, a new sub-pole 11 is installed between the utility poles 10, similar to a conventional pole installation operation.

Thereafter, the wires 31 and the overhead ground wire 32 lifted as described above are seated and installed on the newly installed sub-pole 11 and an overhead ground wire support.

Accordingly, in the main work process S240 of the present invention, as described above, after a safety distance for indirect live-line work on the lower distribution line is secured, the worker may safely access and perform the sub-pole installation operation for distribution lines including one or more circuits.

Further, in the present invention, the main work process S240 may perform a utility pole replacement operation of replacing a utility pole of existing distribution lines including one or more circuits.

In this case, the utility pole replacement operation is performed as follows.

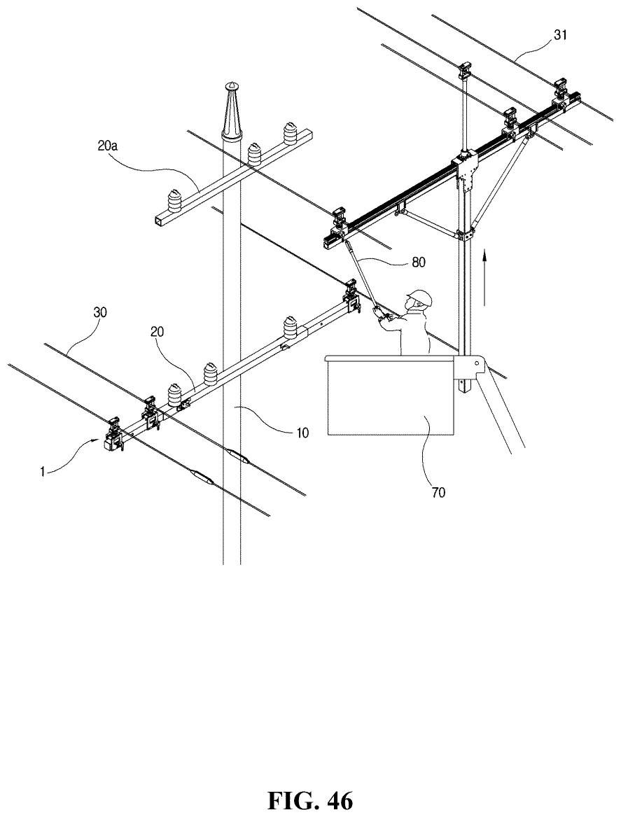

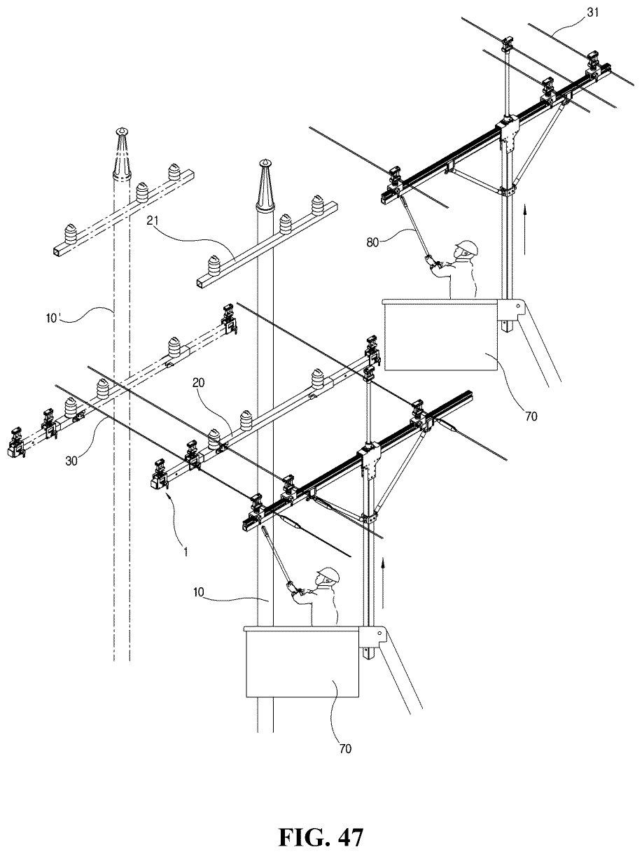

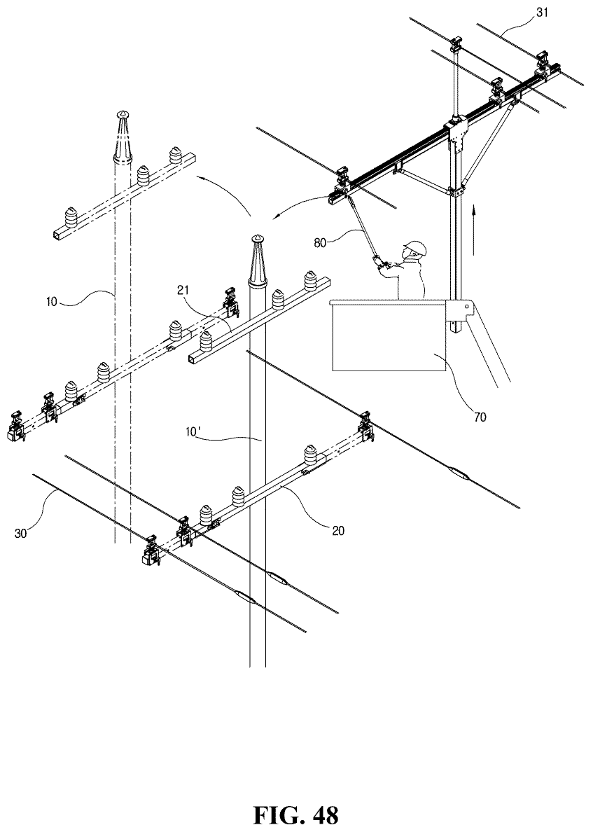

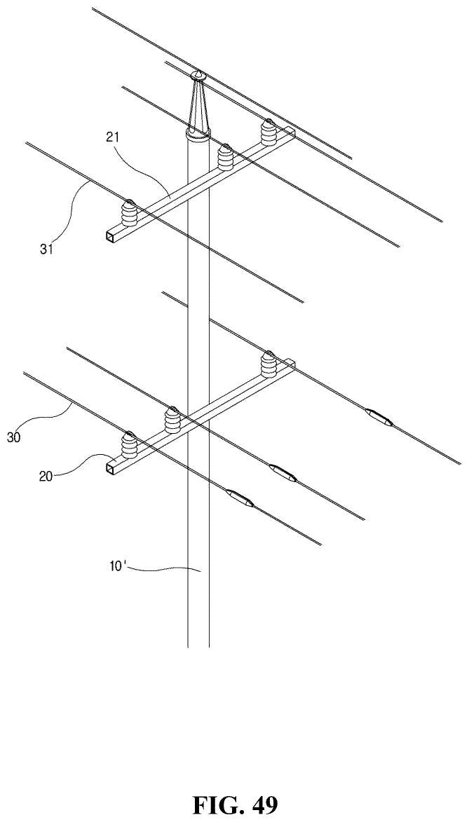

Referring to FIGS. 46 to 49, first, after a safety distance for indirect live-line work on a lower distribution line is secured, the upper distribution line is accessed using the live-line bucket 70.

Thereafter, the wires 30 are moved to a safe location using the conventional indirect live-line lift arm or the like.

Thereafter, the utility pole 10 from which the wires 30 and 31 are separated is removed, and a new utility pole 10′ is installed, similar to a conventional pole installation operation.

Thereafter, the wires 30 of the lower distribution line and the wire 31 and the overhead ground wire 32 of the upper distribution line lifted as described above are seated and installed on the newly installed utility pole 10′, and the existing utility pole 10 to be removed is then removed.

Accordingly, in the main work process S240 of the present invention, as described above, after a safety distance for indirect live-line work on the lower distribution line is secured, the worker may safely access and perform the utility pole replacement operation for distribution lines including one or more circuits.

Further, in the present invention, the main work process S240 may perform a protective device installation operation of installing a protective device, including a protective tube and a protective insulating cover, on an existing upper distribution line.

In this case, the protective device installation operation is performed as follows.

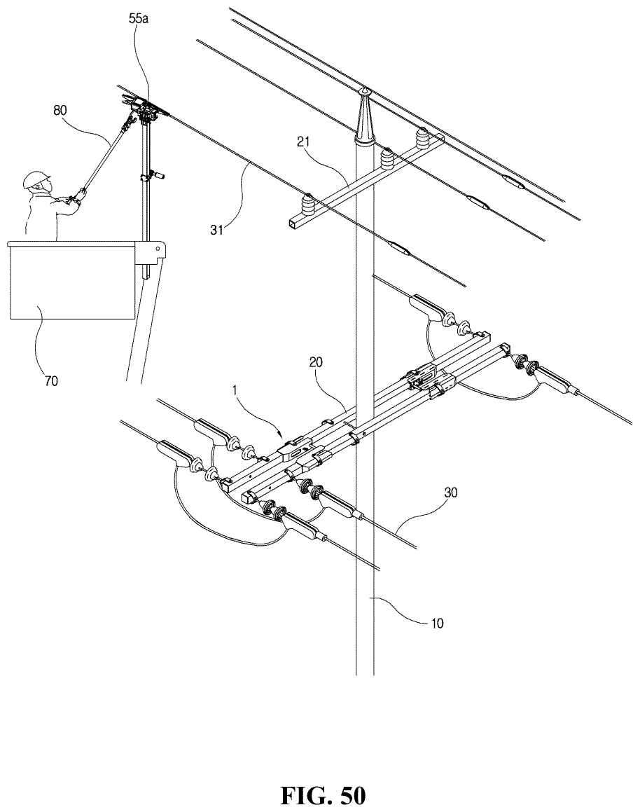

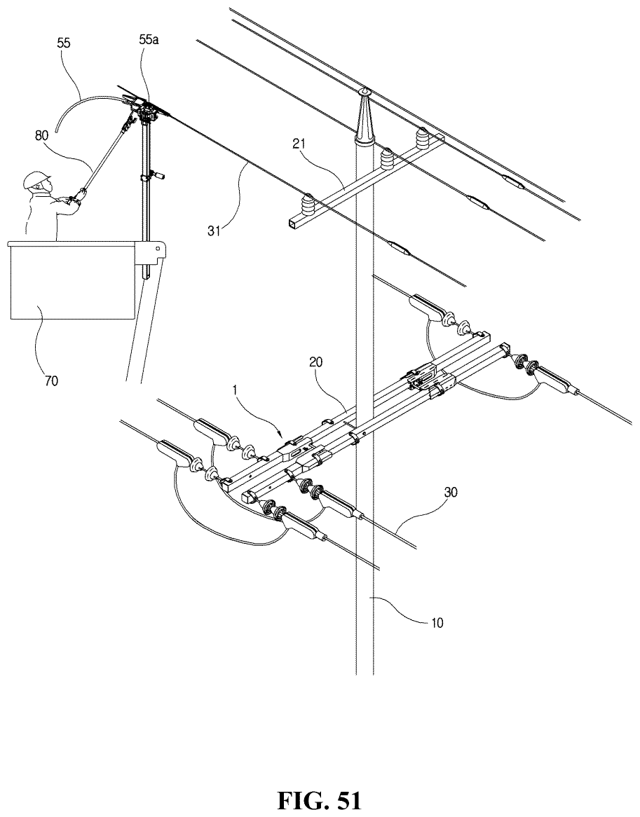

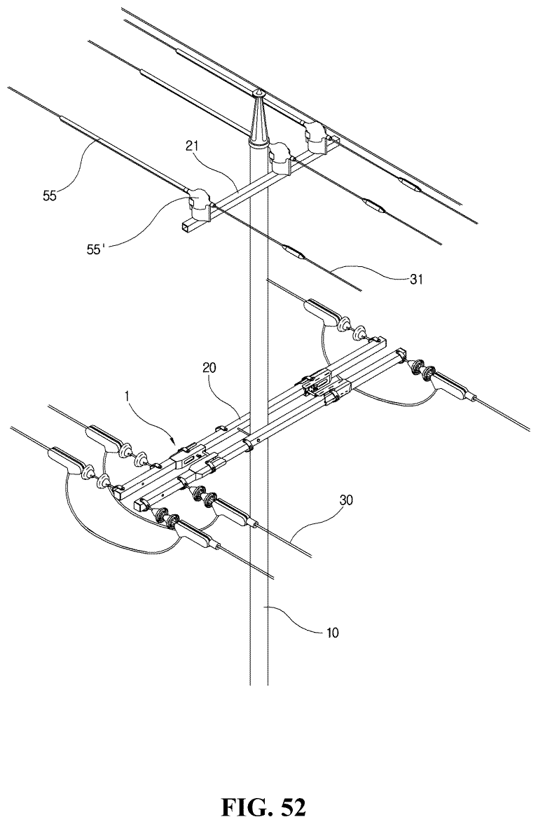

Referring to FIGS. 50 to 52, first, after a safety distance for indirect live-line work on a lower distribution line is secured, the upper distribution line is accessed using the live-line bucket 70.

Thereafter, a conventional protective device inserter 55a is installed, or a tip tool is used on a live-line stick. In an embodiment of the present invention, the conventional protective device inserter 55a is installed and mounted on the wire 31 to be protected.

Thereafter, the protective device 55 is installed. That is, one end of the protective device 55 is coupled to a protective device inserter 55a, and the protective device inserter 55a is operated to wrap and install the wire 31 from a tip end of the protective device 55.

In addition, during installation of the protective device 55, a conventional protective insulating cover 55′ may also be installed on an LP insulator installed on the steel crossarm 21 by indirect live-line work using a live-line work stick or the like.

Thereafter, after installation of the protective device 55 is completed, the installed protective device inserter 55a may be removed.

Accordingly, in the main work process S240 of the present invention, as described above, after a safety distance for indirect live-line work on the lower distribution line is secured, the worker may safely access the upper distribution line and perform the protective device installation operation of the upper distribution line.

Further, in the present invention, the main work process S240 may perform a protective device removal operation of removing a protective device, including a protective tube and a protective insulating cover installed on an existing upper distribution line.

In this case, the protective device removal operation is performed as follows.

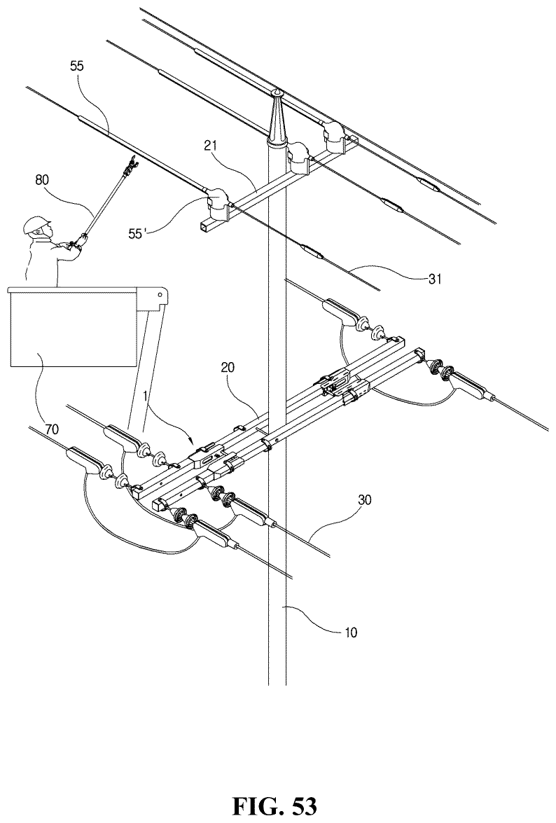

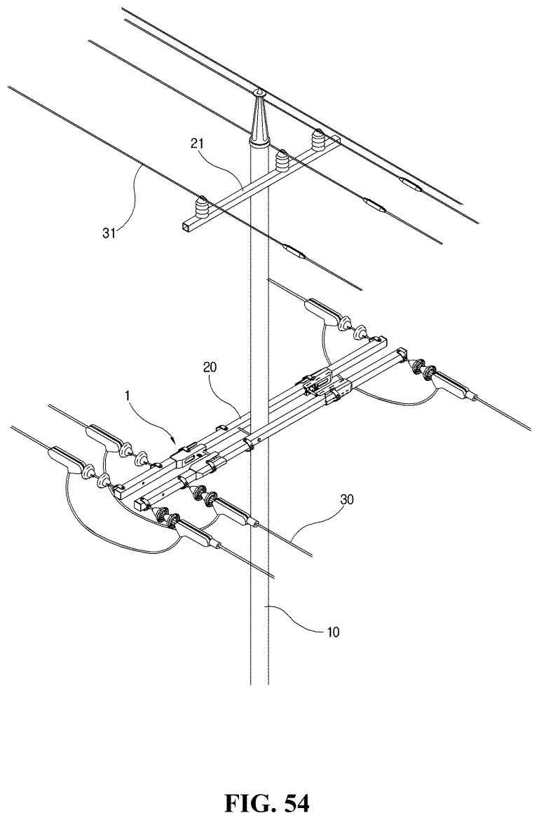

Referring to FIGS. 53 and 54, first, after a safety distance for indirect live-line work on a lower distribution line is secured, the upper distribution line is accessed using the live-line bucket 70.

Thereafter, the protective device 55 and the protective insulating cover 55′ are removed using the conventional live-line work stick 80 or the like.

Accordingly, in the main work process S240 of the present invention, as described above, after a safety distance for indirect live-line work on the lower distribution line is secured, the worker may safely access the upper distribution line and perform the protective device removal operation of the upper distribution line.

Further, in the present invention, the main work process S240 may perform a jumper wire replacement operation of replacing a jumper wire of an existing upper distribution line.

In this case, the jumper wire replacement operation is performed as follows.

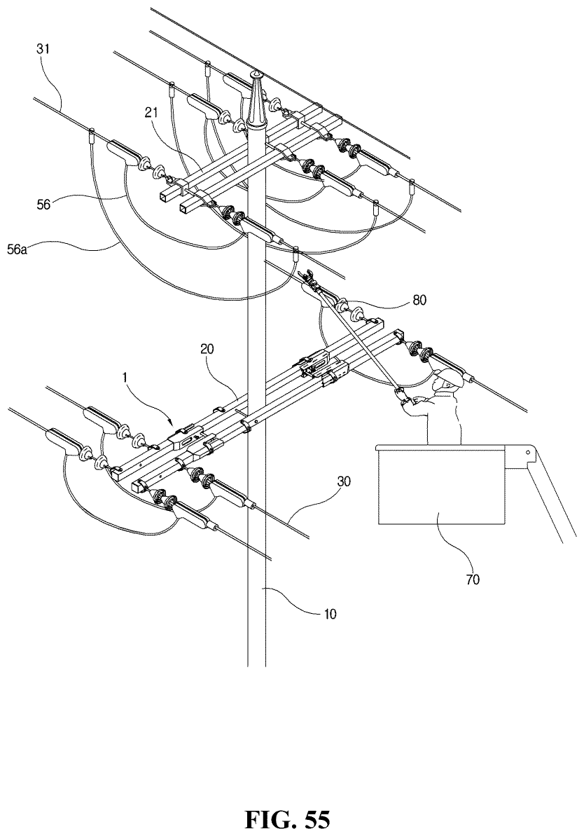

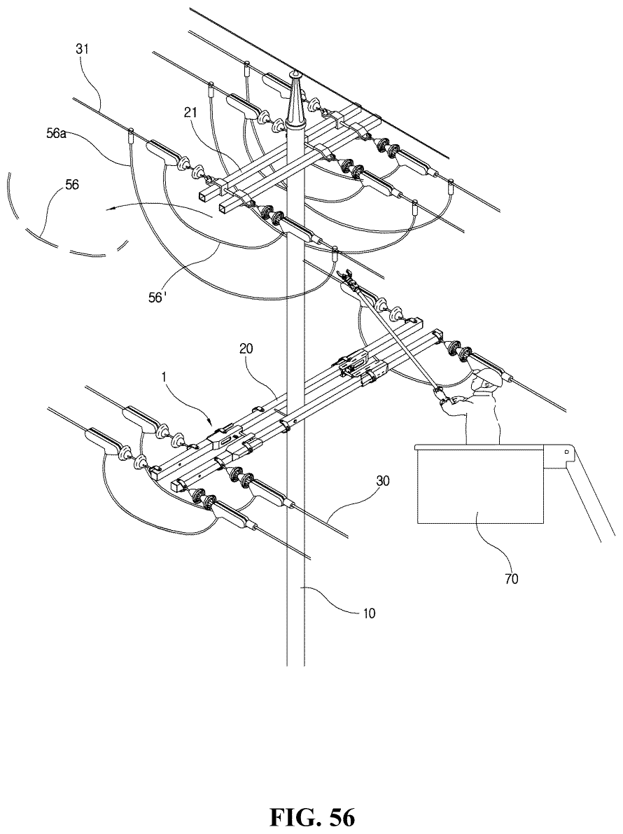

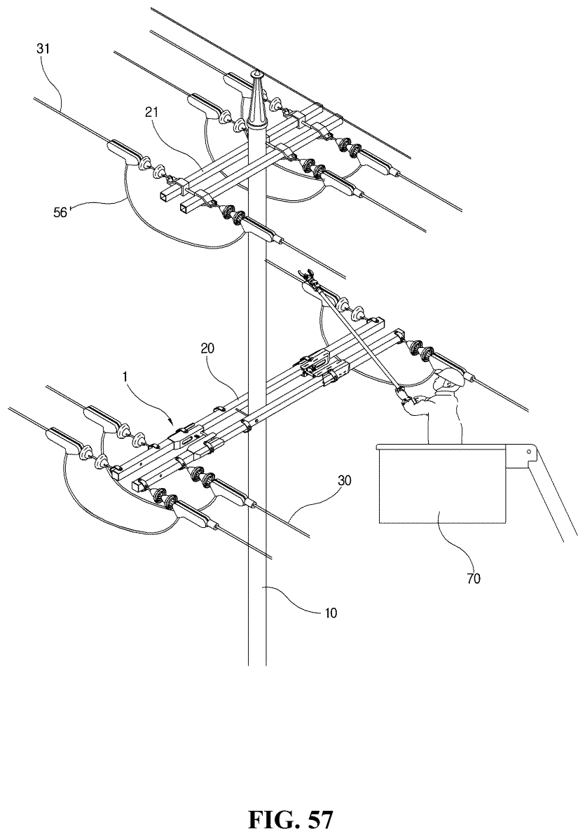

Referring to FIGS. 55 to 57, first, after a safety distance for indirect live-line work on a lower distribution line is secured, the upper distribution line is accessed using the live-line bucket 70.

Thereafter, a bypass jumper cable 56a is installed, and the wires 31 on both sides of the upper distribution line are bypass-connected around the utility pole 10 using the bypass jumper cable 56a.

Thereafter, the existing jumper wire 56 that connects the wires 31 on both sides is separated and removed.

Thereafter, a new jumper wire 56′ is installed by connecting the new jumper wire 56′ at a location where the existing jumper wire 56 is removed, and the bypass jumper cable 56a is then separated and removed.

Accordingly, in the main work process S240 of the present invention, as described above, after a safety distance for indirect live-line work on the lower distribution line is secured, the worker may safely access the upper distribution line and perform the jumper wire replacement operation of the upper distribution line.

Further, in the present invention, the main work process S240 may perform a wire replacement operation of replacing wires on an existing upper distribution line.

In this case, the wire replacement operation is performed as follows.

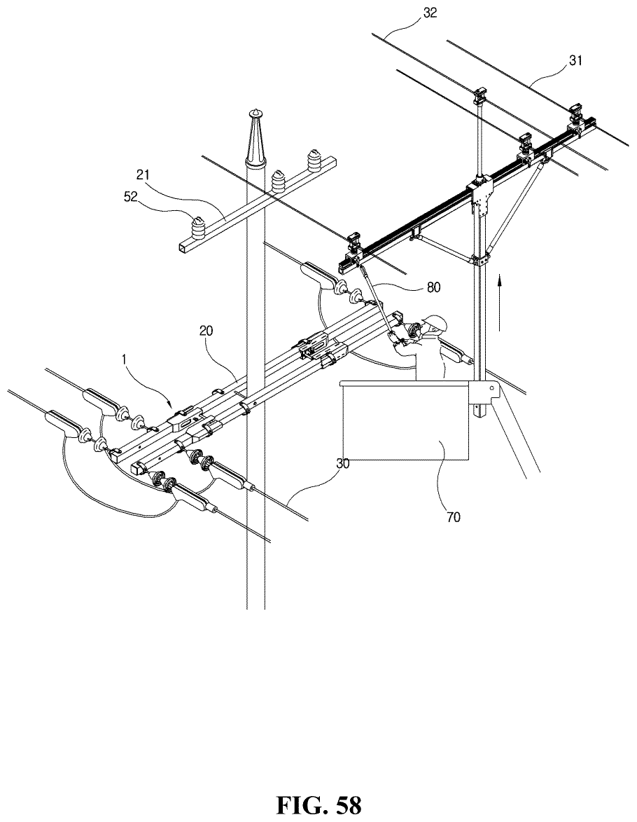

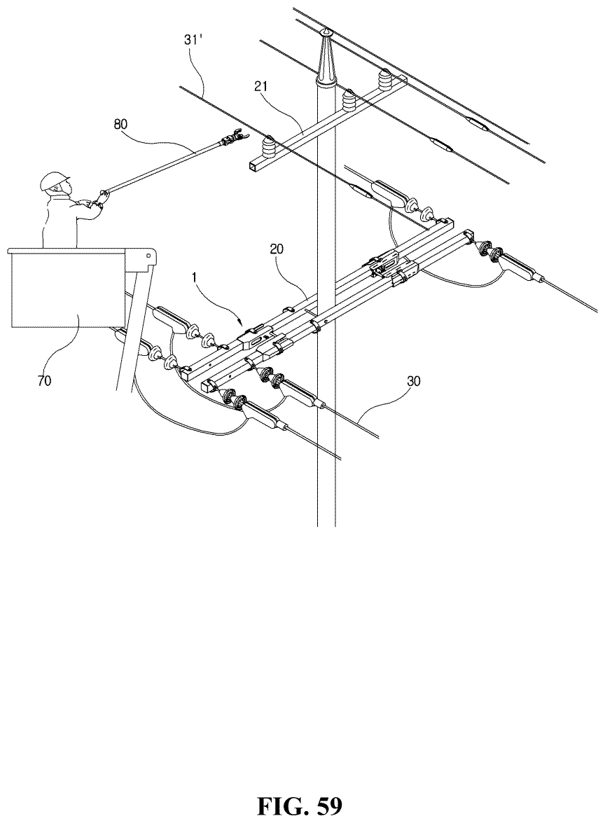

Referring to FIGS. 58 and 59, first, after a safety distance for indirect live-line work on a lower distribution line is secured, the upper distribution line is accessed using the live-line bucket 70.

Thereafter, the old wire 31 is separated from the LP insulator 52 or the suspension insulator of the upper distribution line. In an embodiment of the present invention, separation from the LP insulator 52 will be described as an example.

Thereafter, the separated old wire is removed, and the old wire may be separated using the conventional indirect live-line lift arm or the like.

Thereafter, an installation wire 31′ is installed at a location from which the old wire 31 is removed. Although not illustrated in the drawings, the installation wire 31′ is secured to the LP insulator 52 through conventional wire-stranding and wire-tensioning operations.

Accordingly, in the main work process S240 of the present invention, as described above, after a safety distance for indirect live-line work on the lower distribution line is secured, the worker may safely access the upper distribution line and perform the wire replacement operation of the upper distribution line.

Further, in the present invention, the main work process S240 may perform a line inspection by type operation of inspecting an existing upper distribution line.

In this case, the line inspection by type operation is performed as follows.

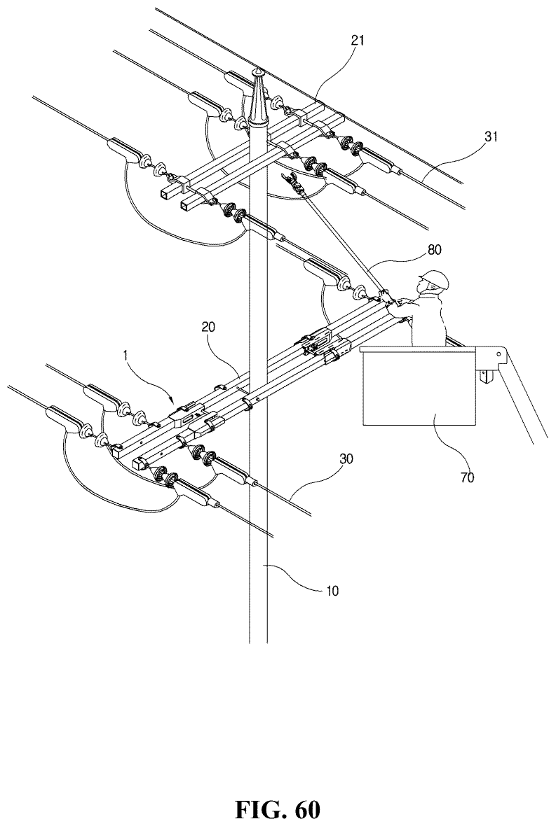

Referring to FIG. 60, first, after a safety distance for indirect live-line work on a lower distribution line is secured, the upper distribution line is accessed using the live-line bucket 70.

Thereafter, a line inspection by type is performed on the upper distribution line. In this case, the line inspection is not limited thereto, and various inspections may be performed on the upper distribution line, such as a condition of a utility pole, a condition of various insulators, a condition of angle, a condition of an LA, a condition of a COS, and a condition of jumper wires.

Accordingly, in the main work process S240 of the present invention, as described above, after a safety distance for indirect live-line work on the lower distribution line is secured, the worker may safely access the upper distribution line and perform the line inspection by type operation of the upper distribution line.

Also, in the present invention, the main work process S240 may perform a switch installation operation on an existing upper distribution line.

In this case, the switch installation operation is performed as follows.

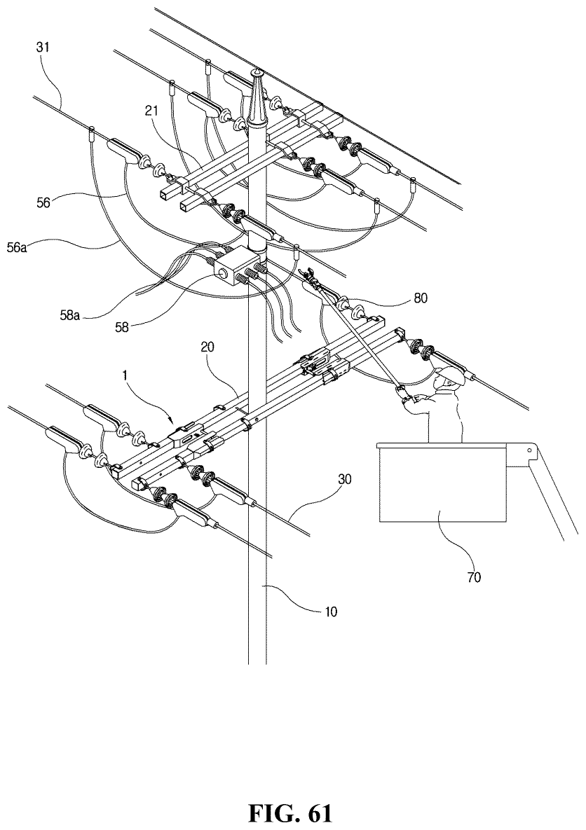

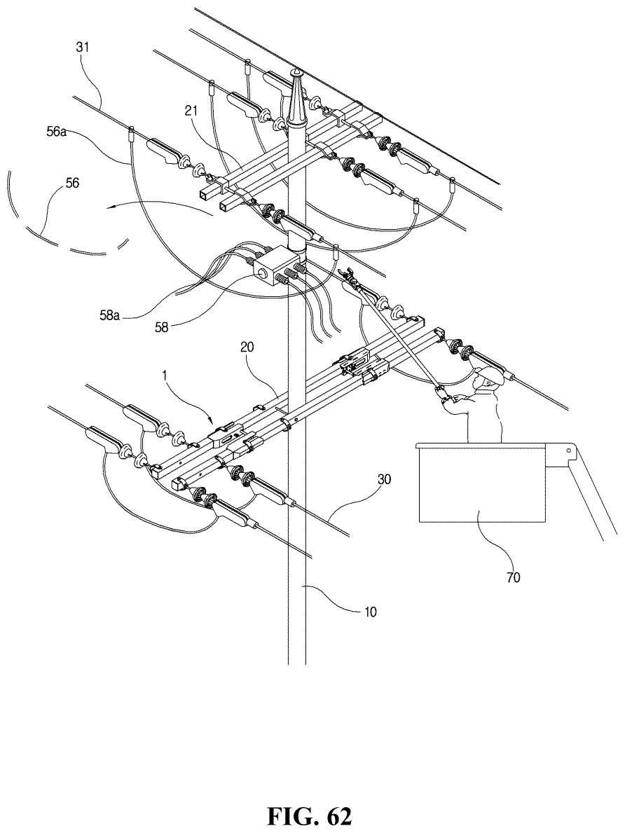

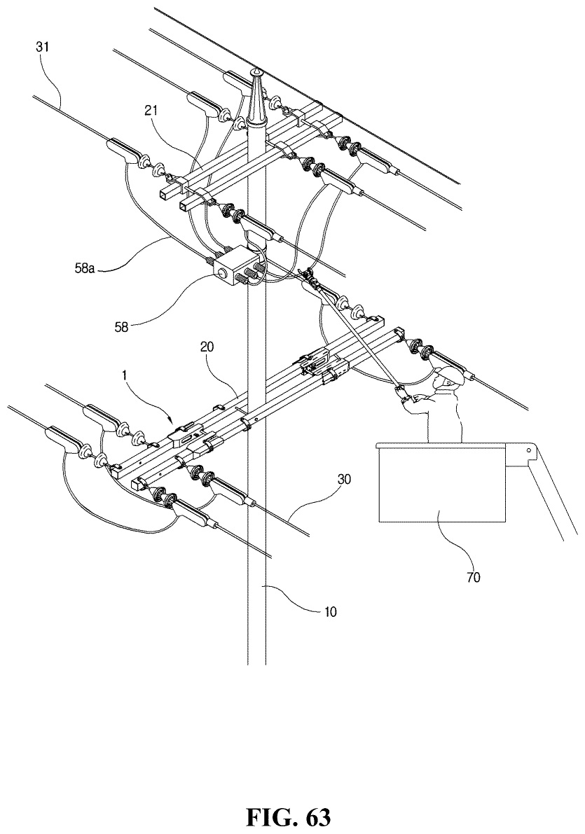

Referring to FIGS. 61 to 63, first, after a safety distance for indirect live-line work on a lower distribution line is secured, the upper distribution line is accessed using the live-line bucket 70.

Thereafter, the bypass jumper cable 56a is installed, and the wires 31 on both sides of the upper distribution line are bypass-connected using the bypass jumper cable 56a centered on the utility pole 10.

Thereafter, an existing jumper wire 56 that connects the wires 31 on both sides is disconnected, a switch 58 is installed and is connected to each of the wires 31 on both sides using a switch cable 58a.

Thereafter, the installed switch 58 is turned on, and the bypass jumper cable 56a is removed.

Accordingly, in the main work process S240 of the present invention, as described above, after a safety distance for indirect live-line work is secured on the lower distribution line, the worker may safely access the upper distribution line and perform the switch installation operation of the upper distribution line.

In addition, in the present invention, the main work process S240 may perform a switch removal operation of removing a switch from an existing upper distribution line.

In this case, the switch removal operation is performed as follows.

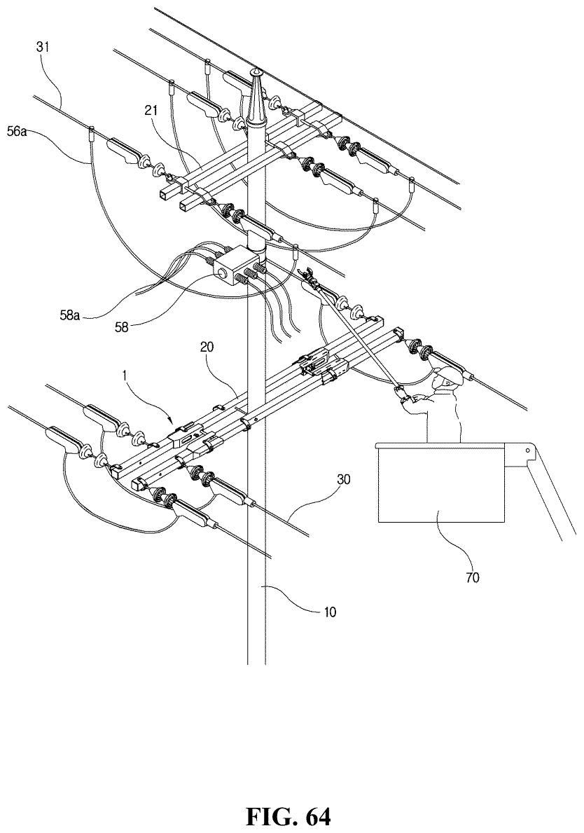

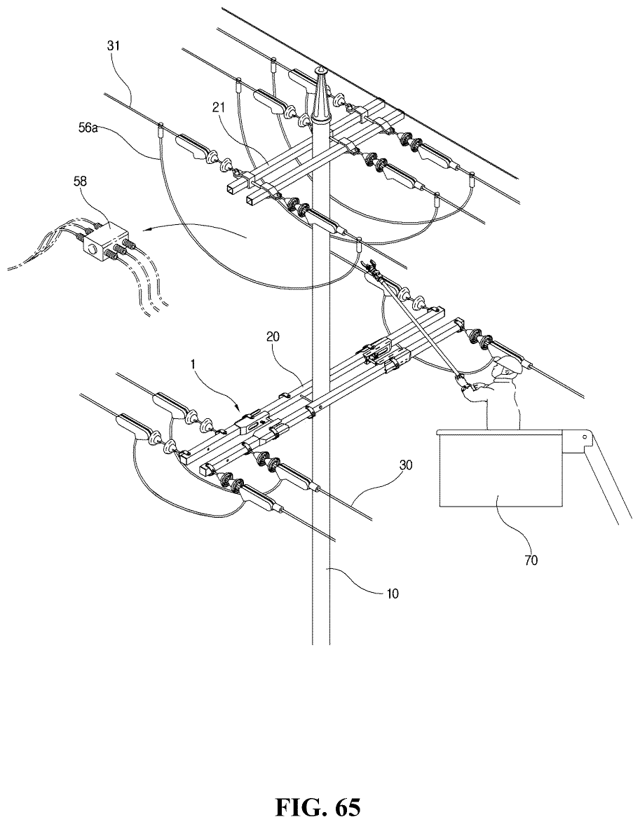

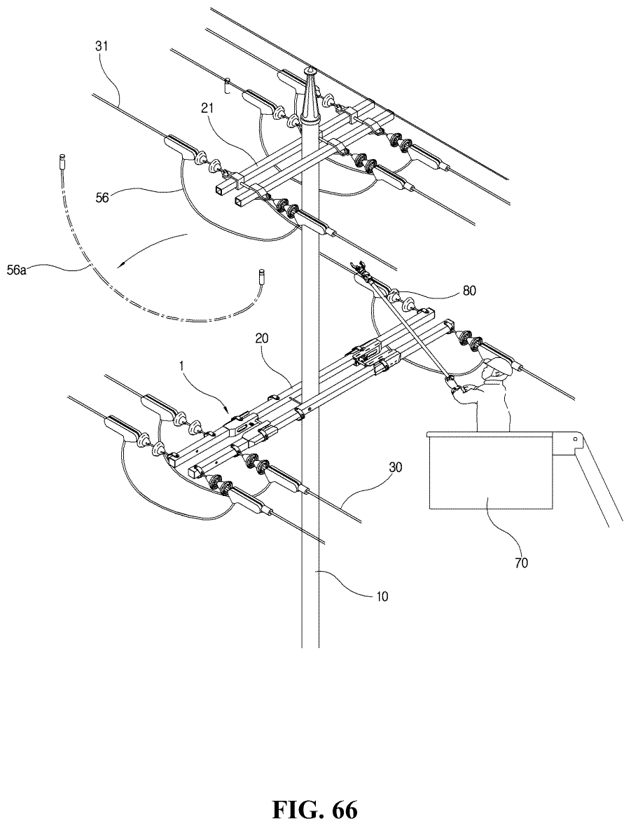

Referring to FIGS. 64 to 66, first, after a safety distance for indirect live-line work on a lower distribution line is secured, the upper distribution line is accessed using the live-line bucket 70.

Thereafter, the wires 31 on both sides of the utility pole 10 are connected using the bypass jumper cable 56a.

Thereafter, the switch 58 is disconnected and removed from the utility pole 10.

Thereafter, the wires 31 on both sides are connected using a new jumper wire 56′, and the bypass jumper cable 56a is separated and removed from the wires 31 on both sides.

Accordingly, in the main work process S240 of the present invention, as described above, after a safety distance for indirect live-line work is secured on the lower distribution line, the worker may safely access the upper distribution line and perform the switch removal operation of the upper distribution line.

Meanwhile, although not illustrated in the drawings, in performing the indirect live-line uninterruptible power distribution method based on the method for securing a safety distance for indirect live-line work using an extension arm of a steel crossarm of the present invention, the steel crossarm 21 formed on the upper and lower distribution lines may be configured and applied as various types of steel crossarms, such as a conventional single steel crossarm, a double steel crossarm, or a single-type built-in steel crossarm, depending on an installation form of the steel crossarm 21 on the utility pole 10.

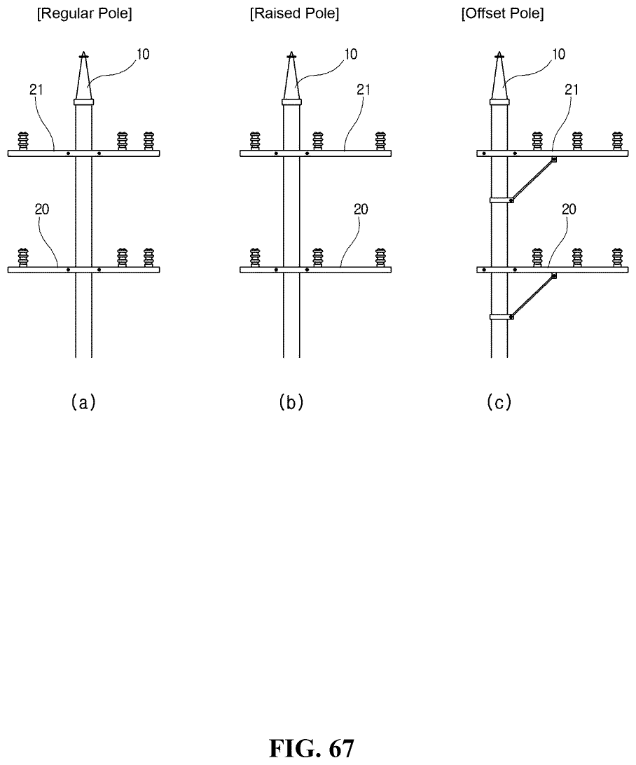

Further, referring to FIG. 67, the steel crossarm 21 may be applied to various types of poles, such as a regular pole (a), a raised pole (b), or an offset pole (c), depending on the installation location of the steel crossarm 21 on the utility pole, and may be applied as a conventional pin-type pole, a strain pole, or a built-in pole depending on the type of pole.

As described above, the indirect live-line uninterruptible power distribution method based on the method for securing a safety distance for indirect live-line work using an extension arm of a steel crossarm of the present invention enables indirect live-line work while securing a safety distance for indirect live-line work for the distribution line when performing work on distribution lines including one or more upper and lower circuits, and in particular, enables simpler and faster indirect live-line work and promotes worker safety.

### INDUSTRIAL APPLICABILITY

The extension arm of a steel crossarm for indirect live-line work, the method for securing a safety distance for indirect live-line work using the same, and the indirect live-line uninterruptible power distribution method based on the method for securing a safety distance for indirect live-line work according to the present invention may secure a safety distance for indirect live-line work through extension of the steel crossarm, thereby enabling safe indirect live-line work on a distribution line. Further, after a safety distance for indirect live-line work is secured by extension of the steel crossarm and movement of wires for distribution lines including one or more upper and lower circuits, a worker may access distribution lines including one or more circuits and an upper distribution line disposed above the same and may safely perform indirect live-line work such as utility pole replacement, steel crossarm replacement, suspension insulator replacement, LP insulator replacement, angle adjustment, installation and removal of an LA, sub-pole installation, protective device installation and removal, jumper wire replacement, wire replacement, line inspection by type, and switch installation and removal.

1. An extension arm of a steel crossarm for indirect live-line work, comprising:
a tubular coupling part 100 having one end open forward and coupled to an end of a steel crossarm of a utility pole;
an extension part 200 extending from a rear end of the coupling part 100 and having a plurality of mounting holes 210; and
a mounting means 300 formed on the coupling part 100 and configured to apply a fixing force to fasten the coupling part 100 to the steel crossarm,
wherein the mounting means 300 comprises:
a plate-shaped support plate 310 extending in a front-rear longitudinal direction, and including a plurality of spacers 311 formed in all directions at a central portion thereof, a guide pin 312 formed at a center of a rear end thereof, a spring support pin 313 formed at a central portion thereof, and a lever guide hole 314 formed as a horizontal slot on a rear side of the spring support pin 313;
an operating plate 320 accommodated between the spacers 311 to slide forward and backward, and including a catch extension 321 formed at a tip end thereof, a spring guide groove 322 formed through a front-middle portion thereof as a horizontal slot into which the spring support pin 313 is inserted, a spring 323 elastically installed on the spring support pin 313 to apply a forward movement force, and a guide pin guide groove 324 formed at a rear end thereof and configured to accommodate and guide the guide pin 312;
a pair of fasteners 330 and 330′ coupled to both sides in a width direction at a front end of the support plate 310, each fastener having a rear end pivotably installed about a shaft 331 of the support plate 310 and a front end configured to be expanded by an elastic force of an opening spring 332 elastically installed therein, and each fastener including a pin fixing groove 333 defined by mutually facing central inner surfaces thereof, and a catch groove 334 defined by mutually facing rear inner surfaces thereof and having a rearwardly expanding step to which the catch extension 321 of the operating plate 320 is engaged; and
an operating lever 340 penetrating the lever guide hole 314 of the support plate 310 and coupled to the operating plate 320, and configured to apply a rearward movement force to the operating plate 320 by indirect live-line work from outside using a live-line work stick.

2. The extension arm of a steel crossarm for indirect live-line work according to Claim 1, wherein the coupling part 100 comprises:
a coupling part 110 for a pin-type pole configured to be applicable to a steel crossarm of a pin-type pole of a distribution line;
a steel crossarm insertion space 111 formed therein and opened forward to allow insertion of the steel crossarm for a pin-type pole;
a steel crossarm guide groove 112 formed on an upper surface thereof, cut to open forward, and configured to guide entry of the steel crossarm;
a pair of fixing pin guide grooves 113 formed by being cut in central portions of both side surfaces thereof and opened forward;
pin hooks 114 having upper portions protruding forward and inclined downward about the fixing pin guide grooves 113;
a working hole 115 formed on a bottom surface thereof to communicate with the steel crossarm insertion space 111; and
a mounting means housing 116 opened forward to allow the mounting means 300 to be mounted, and including a fixing pin guiding groove 117 formed at a tip end of one side surface thereof corresponding to the fixing pin guide grooves 113, and a lever through slot 118 formed at a central portion thereof corresponding to the lever guide hole 314,
wherein the mounting means 300 is configured such that:
when mounted, the support plate 310 is fixed to an inner side of the mounting means housing 116 so that the fasteners 330 and 330′ are positioned forward, the opening spring 332 is elastically installed inside the mounting means housing 116, and when mounted, the operating lever 340 passes through the lever through slot 118 and the lever guide hole 314 and is fixed to the operating plate 320.

3. The extension arm of a steel crossarm for indirect live-line work according to Claim 1, wherein the coupling part 100 comprises:
a coupling part 120 for a built-in pole configured to be applicable to a steel crossarm of a built-in pole of a distribution line;
a steel crossarm insertion space 121 formed therein and opened forward to allow insertion of the steel crossarm for a built-in pole;
pin guide grooves 122 formed by being cut in upper and lower surfaces thereof and opened forward;
a pair of bolt guide grooves 123 formed by being cut in central portions of tip ends of both side surfaces thereof and opened forward;
a mounting means housing 125 including a bolt guide groove 126 having one side surface opened forward such that the mounting means 300 is mounted and formed at a tip end thereof corresponding to the bolt guide grooves 123, and a lever through slot 127 formed at a central portion thereof corresponding to the lever guide hole 314; and
an inclined reinforcement part 128 protruding from the other side surface to be inserted and installed through a gap between bolt shackles,
wherein the mounting means 300 is configured such that:
when mounted, the support plate 310 is fixed to an inner side of the mounting means housing 125 so that the fasteners 330 and 330′ are positioned forward, the opening spring 332 is elastically installed inside the mounting means housing 125, and when mounted, the operating lever 340 passes through the lever through slot 127 and the lever guide hole 314 and is fixed to the operating plate 320.

4. The extension arm of a steel crossarm for indirect live-line work according to Claim 1, wherein the coupling part 100 comprises:
a coupling part 130 for a single built-in pole configured to be applicable to a steel crossarm for a single built-in pole of a distribution line;
wherein the coupling part 130 for a single built-in pole is configured to have a diameter smaller than a diameter of the steel crossarm for a single built-in pole so as to be insertable into an interior of the steel crossarm for a single built-in pole;
pin guide grooves 131 cut to open forward and formed in upper and lower surfaces thereof; and
a lever through slot 132 formed in an upper surface thereof at a rear of the pin guide groove 131 corresponding to the lever guide hole 314,
wherein the mounting means 300 is configured such that:
when mounted, the support plate 310 is fixed to an inner upper portion of the coupling part 130 for a single built-in pole so that the fasteners 330 and 330′ are positioned forward, the opening spring 332 is elastically installed inside the coupling part 100, and when mounted, the operating lever 340 passes through the lever through slot 132 and the lever guide hole 314 and is fixed to the operating plate 320.

5. A method for securing a safety distance for indirect live-line work using an extension arm of a steel crossarm, which performs indirect live-line work on extra-high-voltage distribution lines including one or more upper and lower circuits using the extension arm of a steel crossarm for indirect live-line work according to claim 1, the method comprising:
a work preparation process (S110) of carrying live-line work equipment, such as an extension arm of a steel crossarm for indirect live-line work for extending a steel crossarm, including a live-line work stick, and moving to the distribution line using a live-line bucket;
a steel crossarm extension process (S120) of extending a steel crossarm by coupling the extension arm of a steel crossarm for indirect live-line work to one or both sides of a steel crossarm of the distribution line by indirect live-line work using the live-line work stick and the live-line work equipment;
a safety distance securing process (S130) of securing a safety distance for indirect live-line work by moving a wire of the distribution line to the extension arm of a steel crossarm for indirect live-line work;
a wire return process (S140) of moving the wire of the distribution line, which has been moved to the extension arm of a steel crossarm for indirect live-line work, back to the steel crossarm; and
a finishing process (S150) of removing the live-line work equipment, such as the extension arm of a steel crossarm for indirect live-line work, using the live-line work stick and the live-line work equipment.

6. An indirect live-line uninterruptible power distribution method based on the method for securing a safety distance for indirect live-line work using an extension arm of a steel crossarm, which performs indirect live-line work on extra-high-voltage distribution lines including one or more upper and lower circuits using the extension arm of a steel crossarm for indirect live-line work according to claim 1, the method comprising:
a work preparation process (S210) of carrying live-line work equipment, such as an extension arm of a steel crossarm for indirect live-line work for extending a steel crossarm, including a live-line work stick, and moving to the distribution line using a live-line bucket;
a steel crossarm extension process (S220) of extending the steel crossarm by coupling the extension arm of a steel crossarm for indirect live-line work to one or both sides of a steel crossarm of the distribution line by indirect live-line work using the live-line work stick and the live-line work equipment;
a safety distance securing process (S230) of securing a safety distance for indirect live-line work by moving a wire of the distribution line to the extension arm of a steel crossarm for indirect live-line work;
a main work process (S240) of, after a safety distance for indirect live-line work is secured, performing indirect live-line work on the distribution line using the live-line bucket, by a worker;
a wire return process (S250) of, after the indirect live-line work on the distribution line is completed, moving the wire of the distribution line, which has been moved to the extension arm of a steel crossarm for indirect live-line work, back to the steel crossarm; and
a finishing process (S260) of removing the live-line work equipment, such as the extension arm of a steel crossarm for indirect live-line work, using the live-line work stick and the live-line work equipment.

7. The indirect live-line uninterruptible power distribution method based on the method for securing a safety distance for indirect live-line work using an extension arm of a steel crossarm according to claim 6,
wherein the main work process S240 performs a pole replacement operation of replacing a pin-type pole of an existing upper distribution line with a built-in pole, and
wherein the pole replacement operation is performed as follows:
after a safety distance for indirect live-line work on a lower distribution line is secured, accessing the upper distribution line using the live-line bucket and separating a wire from an LP insulator of the upper distribution line;
removing an existing steel crossarm for a pin-type pole and installing a new steel crossarm for a built-in pole;
installing wire tensioners on both sides of the installed steel crossarm for a built-in pole, bringing the wire close to the wire tensioners, and holding both sides of the wire using the wire tensioners; and
connecting and fixing the wire to a suspension insulator, and removing the wire tensioners.

8. The indirect live-line uninterruptible power distribution method based on the method for securing a safety distance for indirect live-line work using an extension arm of a steel crossarm according to claim 6,
wherein the main work process S240 performs a steel crossarm replacement operation of replacing an existing steel crossarm of an upper distribution line with a new steel crossarm, and
wherein the steel crossarm replacement operation is performed as follows:
after a safety distance for indirect live-line work on a lower distribution line is secured, accessing the upper distribution line using the live-line bucket and separating a wire of the upper distribution line from the existing steel crossarm;
removing the existing steel crossarm and installing a new steel crossarm; and
seating, installing, and fixing the wire on the installed new steel crossarm.

9. The indirect live-line uninterruptible power distribution method based on the method for securing a safety distance for indirect live-line work using an extension arm of a steel crossarm according to claim 6,
wherein the main work process S240 performs a suspension insulator replacement operation of replacing an existing suspension insulator of an upper distribution line with a new suspension insulator, and
wherein the suspension insulator replacement operation is performed as follows:
after a safety distance for indirect live-line work on a lower distribution line is secured, accessing the upper distribution line using the live-line bucket, installing a wire tensioner on a steel crossarm of the upper distribution line, and fixing a wire using the wire tensioner;
pulling the installed wire tensioner to render the suspension insulator in a tension-free state;
removing the existing suspension insulator from the steel crossarm in the tension-free state and installing a new suspension insulator in the removed location; and
releasing the wire tensioner to relieve tension applied to the wire and removing the wire tensioner.

10. The indirect live-line uninterruptible power distribution method based on the method for securing a safety distance for indirect live-line work using an extension arm of a steel crossarm according to claim 6,
wherein the main work process S240 performs an LP insulator replacement operation of replacing an existing LP insulator of an upper distribution line with a new LP insulator, and
wherein the LP insulator replacement operation is performed as follows:
after a safety distance for indirect live-line work on a lower distribution line is secured, accessing the upper distribution line using the live-line bucket and separating a wire fixed to the LP insulator of the upper distribution line;
separating and removing the existing LP insulator fixed to a steel crossarm from the steel crossarm;
installing a new LP insulator at the location from which the existing LP insulator was removed; and
seating and fixing the wire on an upper portion of the new LP insulator.

11. The indirect live-line uninterruptible power distribution method based on the method for securing a safety distance for indirect live-line work using an extension arm of a steel crossarm according to claim 6,
wherein the main work process S240 performs an angle adjustment operation of adjusting an angle of an existing upper distribution line, and
wherein the angle adjustment operation is performed as follows:
after a safety distance for indirect live-line work on a lower distribution line is secured, accessing the upper distribution line using the live-line bucket, installing a wire tensioner on a steel crossarm of the upper distribution line, and fixing a wire using the wire tensioner;
adjusting the angle by pulling or releasing the fixed wire by operating the wire tensioner;
detaching a dead-end clamp of the wire whose angle has been adjusted and reinstalling the dead-end clamp at the adjusted location to connect and fix the wire; and
releasing the wire tensioner to relieve tension applied to the wire, and removing the wire tensioner.

12. The indirect live-line uninterruptible power distribution method based on the method for securing a safety distance for indirect live-line work using an extension arm of a steel crossarm according to claim 6,
wherein the main work process S240 performs an LA installation operation of installing an LA (lightning arrester) on an existing upper distribution line, and
wherein the LA installation operation is performed as follows:
after a safety distance for indirect live-line work on a lower distribution line is secured, accessing the upper distribution line using the live-line bucket and installing the LA on the upper distribution line;
connecting a ground wire of the installed LA to a pole ground wire; and
connecting the installed LA and a wire using a primary-side lead wire.

13. The indirect live-line uninterruptible power distribution method based on the method for securing a safety distance for indirect live-line work using an extension arm of a steel crossarm according to claim 6,
wherein the main work process S240 performs an LA removal operation of removing an existing LA (lightning arrester) installed on an existing upper distribution line, and
wherein the LA removal operation is performed as follows:
after a safety distance for indirect live-line work on a lower distribution line is secured, accessing the upper distribution line using the live-line bucket and disconnecting a primary-side lead wire of the existing LA installed on the upper distribution line;
disconnecting a ground wire of the existing LA that is connected to the wire; and
releasing a fixing force of the existing LA from a steel crossarm and separating the existing LA from the steel crossarm.

14. The indirect live-line uninterruptible power distribution method based on the method for securing a safety distance for indirect live-line work using an extension arm of a steel crossarm according to claim 6,
wherein the main work process S240 performs a sub-pole installation operation of newly installing a sub-pole between utility poles to install existing distribution lines including one or more circuits, and
wherein the installation operation of the new sub-pole is performed as follows:
after a safety distance for indirect live-line work on a lower distribution line is secured, accessing an upper distribution line using the live-line bucket and separating a wire and an overhead ground wire of the upper distribution line and moving the wire and the overhead ground wire to a safe location;
installing a new sub-pole between the utility poles;
installing an overhead ground wire support and a utility pole on the newly installed sub-pole; and
seating and installing the wire on the utility pole of the newly installed sub-pole and installing the overhead ground wire on the overhead ground wire support of the newly installed sub-pole.

15. The indirect live-line uninterruptible power distribution method based on the method for securing a safety distance for indirect live-line work using an extension arm of a steel crossarm according to claim 6,
wherein the main work process S240 performs a utility pole replacement operation of replacing an existing utility pole of distribution lines including one or more circuits, and
wherein the pole replacement operation is performed as follows:
after a safety distance for indirect live-line work on a lower distribution line is secured, accessing an upper distribution line using the live-line bucket and separating a wire and an overhead ground wire of the upper distribution line and moving the wire and the overhead ground wire to a safe location;
installing a new utility pole;
connecting and fixing an upper wire to the new utility pole by installing a steel crossarm;
separating a wire of the lower distribution line and moving the wire to the safe location of the new utility pole; and
removing the existing utility pole and connecting and fixing the wire to the new utility pole.

16. The indirect live-line uninterruptible power distribution method based on the method for securing a safety distance for indirect live-line work using an extension arm of a steel crossarm according to claim 6,
wherein the main work process S240 performs a protective device installation operation of installing a protective device on an existing upper distribution line, and
wherein the protective device installation operation is performed as follows:
after a safety distance for indirect live-line work on a lower distribution line is secured, accessing the upper distribution line using the live-line bucket and installing a protective device tool on the upper distribution line, or installing a tip tool on a live-line work stick;
installing the protective device by wrapping the protective device around a wire using the installed protective device tool or the tip tool; and
removing the protective device tool or the tip tool used.

17. The indirect live-line uninterruptible power distribution method based on the method for securing a safety distance for indirect live-line work using an extension arm of a steel crossarm according to claim 6,
wherein the main work process S240 performs a protective device removal operation of removing a protective device from an existing upper distribution line, and
wherein the protective device removal operation is performed as follows:
after a safety distance for indirect live-line work on a lower distribution line is secured, accessing the upper distribution line using the live-line bucket; and
removing the protective device by indirect live-line work using the live-line work stick.

18. The indirect live-line uninterruptible power distribution method based on the method for securing a safety distance for indirect live-line work using an extension arm of a steel crossarm according to claim 6,
wherein the main work process S240 performs a jumper wire replacement operation of replacing a jumper wire of an existing upper distribution line, and
wherein the jumper wire replacement operation is performed as follows:
after a safety distance for indirect live-line work on a lower distribution line is secured, accessing the upper distribution line using the live-line bucket, and connecting wires on both sides of the upper distribution line using a bypass jumper cable centered on a utility pole;
removing an existing jumper wire that connects and fixes the wires on both sides; and
installing a new jumper wire at a location from which the existing jumper wire has been removed, and removing the bypass jumper cable.

19. The indirect live-line uninterruptible power distribution method based on the method for securing a safety distance for indirect live-line work using an extension arm of a steel crossarm according to claim 6,
wherein the main work process S240 performs a wire replacement operation of replacing wires of an existing upper distribution line, and
wherein the wire replacement operation is performed as follows:
after a safety distance for indirect live-line work on a lower distribution line is secured, accessing the upper distribution line using the live-line bucket, and separating an old wire from an LP insulator or a suspension insulator of the upper distribution line;
removing the separated old wire using an indirect live-line lift arm; and
installing and fixing an installation wire on the LP insulator or the suspension insulator from which the old wire has been separated.

20. The indirect live-line uninterruptible power distribution method based on the method for securing a safety distance for indirect live-line work using an extension arm of a steel crossarm according to claim 6,
wherein the main work process S240 performs a line inspection by type operation of inspecting an existing upper distribution line, and
wherein the line inspection by type operation is performed as follows:
after a safety distance for indirect live-line work on a lower distribution line is secured, accessing the upper distribution line using the live-line bucket and inspecting the upper distribution line.

21. The indirect live-line uninterruptible power distribution method based on the method for securing a safety distance for indirect live-line work using an extension arm of a steel crossarm according to claim 6,
wherein the main work process S240 performs a switch installation operation of installing a switch on an existing upper distribution line, and
wherein the switch installation operation is performed as follows:
after a safety distance for indirect live-line work on a lower distribution line is secured, accessing the upper distribution line and connecting wires on both sides of the upper distribution line with a bypass jumper cable centered on a utility pole using the live-line bucket;
disconnecting an existing jumper wire that connects and fixes the wires on both sides;
installing the switch on the utility pole and turning on the switch; and
removing the bypass jumper cable.

22. The indirect live-line uninterruptible power distribution method based on the method for securing a safety distance for indirect live-line work using an extension arm of a steel crossarm according to claim 6,
wherein the main work process S240 performs a switch removal operation of removing a switch from an existing upper distribution line, and
wherein the switch removal operation is performed as follows:
after a safety distance for indirect live-line work on a lower distribution line is secured, accessing the upper distribution line using the live-line bucket and connecting wires on both sides of the upper distribution line with bypass jumper cables centered on a utility pole;
removing the switch from the utility pole;
connecting new jumper wires to the wires on both sides; and
removing the bypass jumper cables.

23. The indirect live-line uninterruptible power distribution method based on the method for securing a safety distance for indirect live-line work using an extension arm of a steel crossarm according to claim 6,
wherein upper and lower distribution lines to be worked on comprise a single steel crossarm, a double steel crossarm, or a single-type built-in steel crossarm, depending on an installation form of the steel crossarm on the utility pole, and
are used as a pin-type pole, a strain pole, or a built-in pole in the form of a regular pole, a raised pole, or an offset pole, depending on an installation location of the steel crossarm on the utility pole and a pole installation method.
